(19) United States
(12) Patent Application Publication
(10) Pub. No.: US 2015/0149585 A1
(43) Pub. Date: May 28, 2015

(54) CHANNEL-CONTENT MANAGEMENT SYSTEM FOR CONTROLLING DYNAMIC-CONTENT TRANSMISSIONS FOR PASSIVE DISPLAY ON COMPUTING DEVICES

(71) Applicant: Jack Ke Zhang, Ijamsville, MD (US)

(72) Inventor: Jack Ke Zhang, Ijamsville, MD (US)

(21) Appl. No.: 14/101,103

(22) Filed: Dec. 9, 2013

Related U.S. Application Data
(60) Provisional application No. 61/908,899, filed on Nov. 26, 2013.

(51) Int. Cl. H04L 29/08

(52) U.S. Cl. CPC H04L 67/10
USPC 709/217

(57) ABSTRACT

Techniques for transmitting and presenting content may be provided. In particular, systems and methods are provided for allowing third parties (e.g., “publishers”) to specify content items to be transmitted, via channels, to a plurality of devices (e.g., subscriber devices). Content items can include, e.g., product information, promotion details or institution-level notifications and can dynamically change in time. In one instance, a publisher can periodically update content (e.g., images, videos or text) based on, e.g., current or future promotions, new product launches or recent events. One or more content items can then be transmitted via a channel to devices of subscribers of the channel (e.g., simultaneously or asynchronously). When inactivity is detected at a particular subscriber's device, the device can present one or more content items from the channel. In some instances, the channel's content item(s) is sequential to or interleaved with content items from another channel.

### CROSS-REFERENCES TO RELATED APPLICATIONS

This application claims the benefit or and priority to U.S. Provisional Application 61/908,899, filed on Nov. 26, 2013, which is hereby incorporated by reference in its entirety for all purposes.

### BACKGROUND

Electronic devices provide a variety of useful functions. However, users are not able to continuously actively engage any given electronic device. Consequentially, electronic devices frequently default into a power-saving mode. A power-saving mode may cause a display of an electronic device to turn off or to resort to a pre-defined screen saver. Thus, the display ceases to display timely and pertinent information, and—should the user remain nearby—the utility of the device is frequently greatly diminished.

### SUMMARY

Some embodiments of the present application provide a computer-implemented method implemented as a server. The method may include identifying a computing device that is configured to display channel content. The method may also include identifying a channel that is associated with the computing device. The method may also include detecting an event indicative that a content item associated with the channel is to be transmitted to the computing device. The method may also include identifying a content item that is associated with the channel. The method may also include identifying a destination associated with the content item. The interaction with the content item at the computing device may cause the information from the destination to be sent to the computing device. The method may also include transmitting the content item associated with the channel and an identification of the destination to the computing device.

Some embodiments of the present application include a system comprising at least one memory that stores computer-executable instructions and one or more processors configured to access the memory. The one or more processors may be configured to execute the computer-executable instructions to collectively at least process the method above.

Some embodiments of the present application include one or more computer-readable non-transitory media storing computer-executable instructions that, when executed by one or more computer systems, configure the one or more computer systems to perform operations according to the method above.

Some embodiments of the present application include a computer-implemented method implemented at a computing device. The method may include transmitting a request, from a computing device to a server, to subscribe the computing device to a channel. A corresponding subscription can cause content items for the channel to be periodically sent to the computing device for display on the computing device. The method may also include receiving, at the computing device, a content item for the channel and a destination associated with the content item. The method may also include detecting, at the computing device, an event indicative of entering a display state. The method may also include enabling the computing device to display the content item while the computing device is in the display state. The method may also include detecting an interaction with the content item. In response to detecting the interaction, the method may also include enabling the computing device to display content from the destination.

Some embodiments of the present application include a system comprising at least one memory that stores computer-executable instructions and one or more processors configured to access the memory. The one or more processors may be configured to execute the computer-executable instructions to collectively at least process the method above.

Some embodiments of the present application include one or more computer-readable non-transitory media storing computer-executable instructions that, when executed by one or more computer systems, configure the one or more computer systems to perform operations according to the method above.

### BRIEF DESCRIPTION OF THE DRAWINGS

FIG. 1 shows a block diagram illustrating a system of providing dynamic content transmissions according to an embodiment of the present invention.

FIG. 2 illustrates an example flow diagram of a process for transmitting content between a computing device and a server according to an embodiment of the present invention.

FIG. 3 shows a block diagram illustrating a system of providing dynamic content transmissions according to an embodiment of the present invention.

FIG. 4 illustrates an example architecture for one or more servers in the dynamic content transmission system, including a publishing server and a content delivery/receiving server, according to an embodiment of the present invention.

FIG. 5 illustrates an example flow diagram of a process for transmitting content to a computing device according to an embodiment of the present invention according to an embodiment of the present invention.

FIG. 6 shows an illustration of a graphical user interface for editing a channel according to an embodiment of the present invention.

FIG. 7 illustrates an example flow diagram of a process for transmitting generating and using a playlist.

FIGS. 8A-8D show illustrations of interfaces configured to receive publisher inputs pertinent to a playlist according to an embodiment of the invention.

FIG. 9A shows an illustration of a graphical user interface (GUI) that allows a user to select channels for inclusion in a user playlist according to an embodiment of the present invention.

FIG. 9B shows an illustration of a graphical user interface (GUI) for providing more detailed playlist customization according to an embodiment of the present invention.

FIG. 10 shows an illustration of a playlist, an identification of a set of content items, an order for the content items, a presentation duration for each content item and a source of each content item.

FIG. 11 illustrates a block diagram illustrating a system on a computing device for triggering a presentation of content channels according to an embodiment of the present invention.

FIG. 12 illustrates an example flow diagram of a process for presenting channel content items according to an embodiment of the present invention.

FIG. 13 illustrates an example flow diagram of a process for receiving displaying interactive channel content at a computing device according to an embodiment of the present invention.

FIG. 14 illustrates an interaction between a computing device and server for displaying a destination according to an embodiment of the present invention.

### DETAILED DESCRIPTION

In some embodiments, systems and methods are provided for allowing third parties (e.g., “publishers”) to specify content items to be transmitted, via channels, to a plurality of devices. Content items can include, e.g., video, images, text for various purposes product information, promotion details or institution-level notifications and can dynamically change in time. In one instance, a publisher can periodically update content (e.g., images, videos or text) based on, e.g., current or future promotions, new product launches or recent events. In some embodiments, a publisher can upload content to server from a memory storage, such as the hard disk of a computer. The publisher can provide instruct via an to automatically upload and publish content from a predefined source, such as the featured product image on a home page of an online store associated with the publisher. When a new image is added to the home page, the image can then be automatically uploaded to and displayed in the publisher channel. One or more content items can then be transmitted via a channel to devices of subscribers of the channel (e.g., simultaneously or asynchronously). When inactivity is detected at a particular subscriber's device, the device can present one or more content items from the channel. In some instances, the channel's content item(s) is sequential to or interleaved with content items from another channel.

Channels can facilitate content interaction. For example, a user can enter a particular type of input (e.g., selection of a specific key) to indicatively request more information about the content. A publisher can specify a destination (e.g., a webpage, such as an ordering webpage, an event-registration webpage, an informational webpage, or a file stored on the device) for each of one or more content items. In some cases, there can be a default destination to a content item if no instruction is given by the publisher. The user input can cause the device to route to the destination. Displays and/or interactions with one or more content items can be tracked to support generation of, e.g., marketing statistics for a publisher.

In a non-limiting example, a publisher may generate a golf channel. The publisher can enter channel-defining information about the channel, such as a title, description, and keywords. The publisher can further identify content items (e.g., images or videos) for the channel. In one instance, the publisher can periodically upload content items (e.g., images identifying results of recent golf tournaments, videos promoting sales on golf clubs, text about golfers, or text and images identifying weather conditions at nearby golf courses) to a server. In one instance, the publisher can identify a content source (e.g., a webpage, such as a home page of an online store, as discussed above).

The golf channel can be identified to one or more users (e.g., via an automatic recommendation, a subscription-recommendation push from the publisher to specific user identifiers or email addresses, SMS messages, social media, or as a result for user queries). The users can then subscribe a device (e.g., a workstation, computer, or mobile electronic device) to the channel. Once subscribed, content items from the channel can be displayed on the device when a trigger event is detected. For example, it can be detected that the user's device (e.g., workstation, mobile device) is idle, that a key on a keyboard of the user's device has been selected, that a mobile user device is connected for charging, or that a device has completed or is working on a task (e.g., a phone call has been completed).

Content items for the golf channel can be transmitted from the server to the user's device (e.g., periodically, when the device is entering a channel state, when the device is in a channel state, or when the device is otherwise available to accept content items). When the device enters a display state, one or more content items (e.g., images) from the golf channel may display on the device.

A publisher can further identify a destination (e.g., a webpage) for each of one or more content items. Particular input actions can cause the user device to be directed to the destination. For example, pressing a particular key during display of a content item can cause the user device to request and display a destination webpage that provides additional information pertaining to the item displayed.

A “subscription request” may be a message requesting content items from one or more channels. In some embodiments, the subscription request may be received from a computing device at a server.

A “channel” may be a pipeline between a server and a computing device that provides one or more content items to the computing device. A computing device may be in a channel state when the computing device is able to receive one or more content items via the channel. Similarly, the computing device may be in a display state when the computing device is able to display the one or more content items the computing device received while in the channel state. In a non-limiting example, an action (e.g., a one-button action, such as pressing F10) can cause a device to enter into display state (e.g., regardless of the current state the computing device is in). In another or same example, a same or different action (e.g., a one-button action, such as pressing F9) can cause a device to temporarily suspend the display state during a channel-content display. Such suspend action may also or alternatively be used to prevent the display state from occurring (e.g., even when a device is not in the display state at a time of the suspend action). To illustrate, a cash-register user device may be used to display channel advertising content to one or more customers. When the cashier is processing an order, by pressing F9, the display can be prevented from showing advertising content. In some instances, the suspension can stop when the F10 button is pressed.

A “device playlist” may include one or more identifiers, where each identifier can identify one or more content items received through a channel that are displayed by the computing device or can identify a particular channel. For example, the playlist may include one identifier for an item from the golf channel, two identifiers for two items from a company events channel, and one identifier for an item from an internal medicine channel. The playlist may also include one or more playlist customization parameters to define whether an identifier for a particular channel or content item is active (e.g., in a playlist, presented for display during a display state) and/or associate a priority (e.g., high/low priority, ordered priority) of the item, such that higher priority content items and/or channels may display before other content items and/or channels.

A “channel playlist” may include one or more identifiers, where each identifier can identify one or more content items to be provided within a particular channel. For example, a channel playlist for a jazz channel can include an identifier for each of: five audio-video tracks, a table listing upcoming jazz events and an image with an advertisement for composition software. The playlist may include a sequence or order. In some instances, a portion of a device playlist includes a portion of or all of a channel playlist (e.g., such that it is played in sequence without interruption or such that it is interleaved with other channels' contents). A publisher may be able to set the channel playlist or input information (e.g., content-item prioritization) that can be used to generate the channel playlist.

A “content item” or “content” (used interchangeably) may include an image, video, stream of data, audio, text, or other data provided to a computing device in an electronic format. As shown, content items can include product information, promotion details, or institution-level notifications and can dynamically change in time. In one instance, a publisher can periodically update content based on current or future promotions, new product launches, or recent events. In another instance, when a channel is programmatically linked to a source, the content can be updated when a designated source, such a webpage, receives new updates.

An “event” may be an indication of a changed status at a computing device. For example, an event can include an indication that content items have been transmitted via a channel from a server. In another example, an event can include a notification that the computing device has entered a channel state for receiving content items or a display state for displaying content items. An event may also include a specific key on a key pad being pressed on a computer. An event may also include when an image displayed on a mobile device (or a portion of the image or a portion of a screen) is pressed by a user, which may indicate the user is interested in getting more information.

A “destination” may be a location on a network page that is provided to the computing device or a directory location on the computing device memory by the server when the user of the computing device interacts with a content item. For example, a content item may include an item for sale, such as a pair of shoes. When a specific interaction with the computing device is detected, the computing device may be directed to the destination that sells the shoes, including a network page at a particular uniform resource locator (URL).

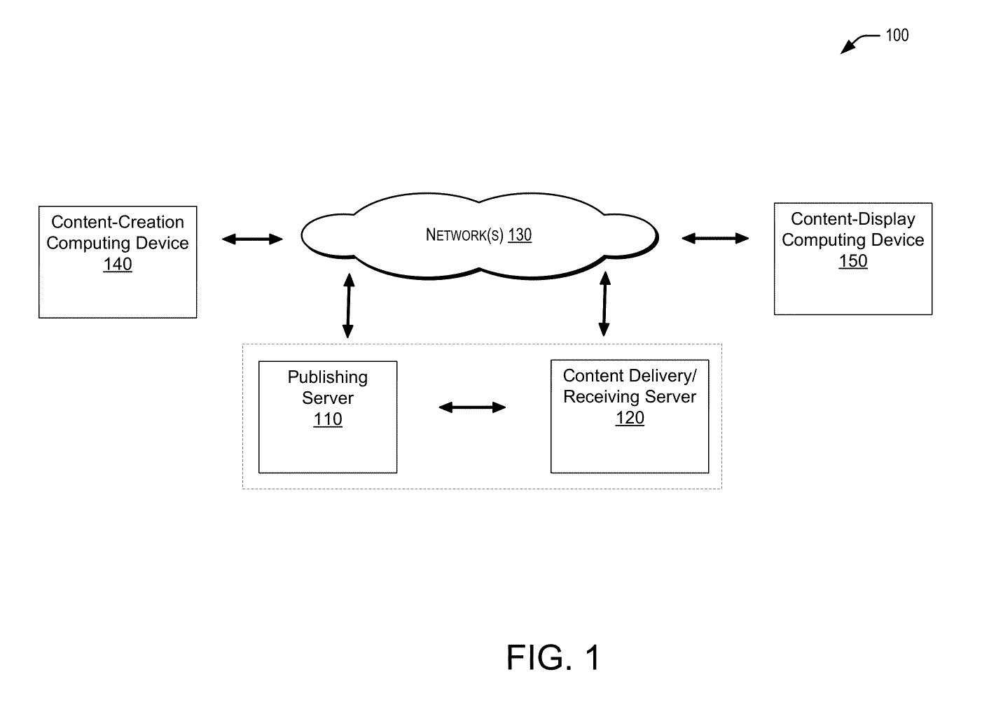

FIG. 1 shows a block diagram illustrating a system for providing dynamic content transmissions according to an embodiment of the present invention. In a non-limiting example, the system 100 can include a publishing server 110, a content delivery/receiving server 120, a network 130, a content-creation computing device 140, and a content-display computing device 150. It will be appreciated that the publishing server 110 and a content delivery/receiving server 120 may be combined into a single server (e.g., as illustrated by the dashed box around the publishing server 110 and content delivery/receiving server 120). Further, while disclosures herein may refer to a single server or computing device, embodiments can be extended to apply to multiple (e.g., joint-operation) servers or computing devices, including mobile computing devices such as mobile phones and tablet computers.

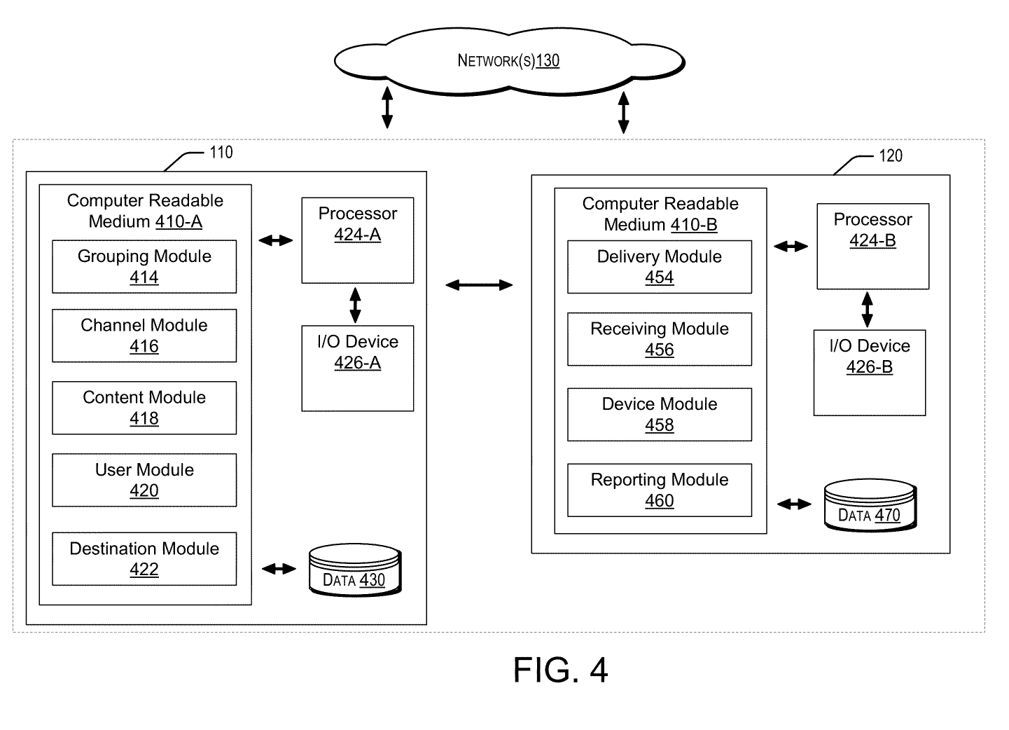

The publishing server 110 can be configured to receive content, associate a destination with the content, generate channels and/or groups, enable channel playlists (e.g., a compilation of content items) to be updated for a device, and provide the content to a content delivery/receiving server 120. Details and function of the publishing server 110 can include those as discussed at greater length in reference to FIG. 4.

The content delivery/receiving server 120 can be configured to provide content items to a computing device, manage a device's profile, a user's profile, provide an administrative platform for content provider devices, and/or manage credentials. Details and function of the content delivery/receiving server 120 can include those further discussed in reference to FIG. 4.

In some embodiments, the publishing server 110 and a content delivery/receiving server 120 may be implemented as a single server with multiple interfaces (e.g., one interface for a publisher, one interface for a user/consumer), a single server with a single interface (e.g., one interface for both a publisher and for a user/consumer, with authentication functionality to distinguish the users), or multiple servers with one or more interfaces.

The network 130 can include one or more networks that allow the publishing server 110, content delivery/receiving server 120, content-creation computing device 140, and/or content-display computing device 150 to communicate. For example, the computing devices may access an application (e.g., a web browser) to communicate with one or more servers via the network 130. In some aspects, the application may be hosted, managed, and/or provided by a computing service or service provider. The network 130 may also include any one or a combination of many different types of networks, such as cable networks, the Internet, wireless networks, cellular networks, private and/or public networks. In some embodiments, the computing devices can interact with servers over a landline phone, via a kiosk, or in any other manner.

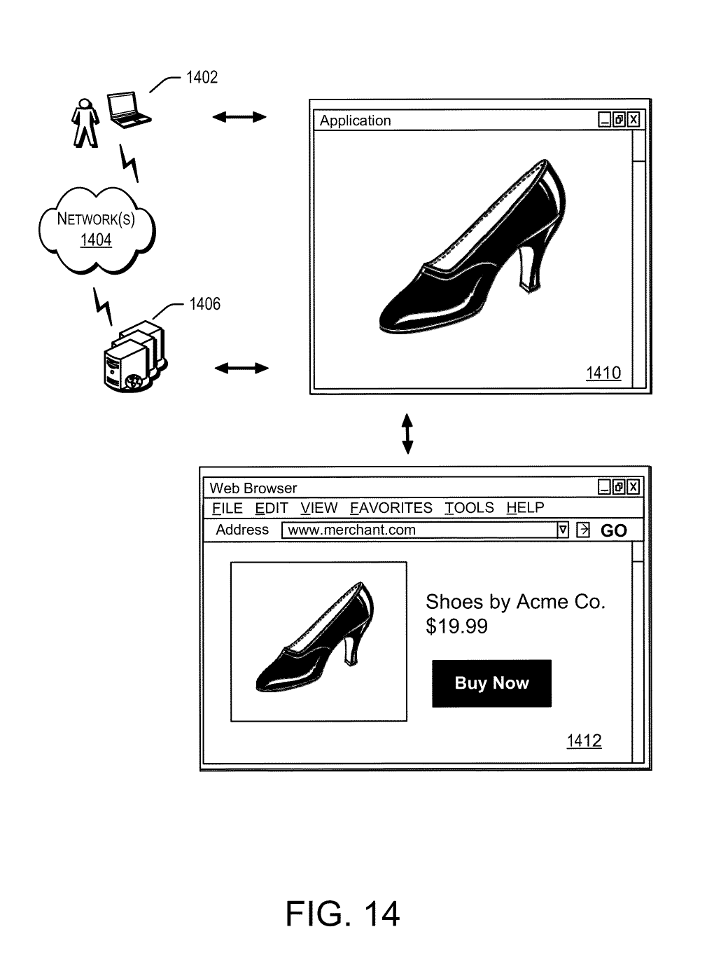

The content-creation computing device 140 can generate content and provide the content to the content delivery/receiving server 120. Details and function of the content-creation computing device 140 can include those discussed at greater length in reference to FIG. 14.

The content-display computing device 150 can automatically request and/or receive content from a content delivery/receiving server 120 and display the content for a user at a computing device. Details and function of the content-display computing device 150 can include those discussed at greater length in reference to FIG. 14.

A user web portal component can further be provided, which can allow a user to enter information pertaining to channel subscriptions. The web portal component can be configured such that a user can access the portal component irrespective as to whether he is using a device that has been, is or will be used to display channel content. The web portal component can nonetheless allow a user to identify information related to channel display. For example, he can identify details for a user profile (e.g., contact information or interests) or channel subscription (e.g., requesting, modifying, removing or prioritizing channels). One, more or all of user inputs described herein and/or reports to a user can be provided via the web portal. Similarly, a publisher may be able to upload and manage content items and channels and view reports pertaining to channels using a web portal.

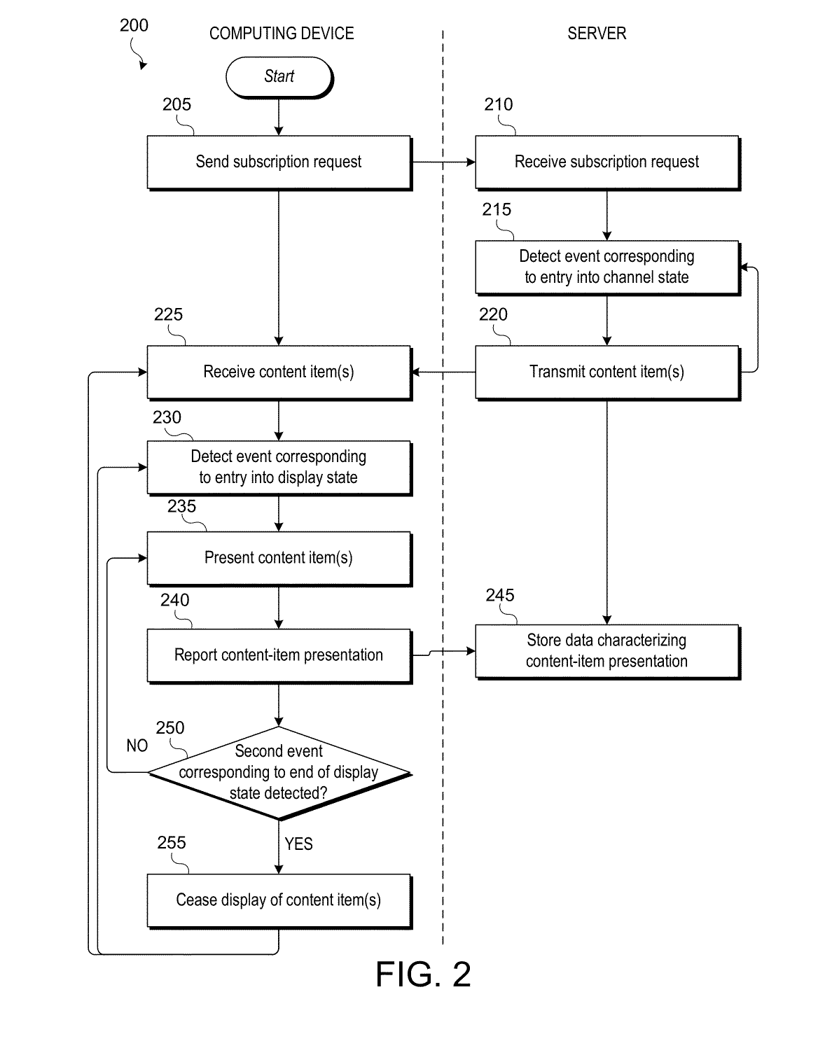

FIG. 2 illustrates an example flow diagram of a process 200 for displaying of a channel's content items on a computing device. As shown, various portions of process 200 can be performed by a computing device (e.g., a content-creation computing device 140, a content-display computing device 150), and other portions can be performed by a server (e.g. a publishing server 110 and/or a content delivery/receiving server 120).

In some embodiments, the user may browse to a webpage and/or graphical user interface (GUI) to find content item(s) and/or channels provided by a server. For example, the user can operate a computing device to search for a channel (e.g., a “Recipes” channel). In other examples, the user can receive a recommendation for a channel (e.g., automatically based on a user profile indicating user's interest, user's interaction history with other content, other channels considered by the user or subscribed to by the user, or based on a publisher's invitation to join the channel). The user may register for or request one or more content items associated with one or more channels.

The process 200 may begin at block 205 when a computing device sends a subscription request to a server (e.g., after a content-displaying computing device installed an application with instructions that, when executed by one or more processors, can perform a method described herein). The subscription request can be a message including device identification and channel identification information from a computing device to a server that requests one or more content items to be transmitted to the computing device. In a non-limiting example, the subscription request contains information about the requester or request, including one or more identifiers of the user (e.g., name, email address, phone number), identifiers of the computing device (e.g., an IP address), identifiers of a type of device (e.g., mobile device, laptop, desktop, tablet or particular brand thereof), identifiers of the content item(s) and/or channel, operating system(s), channel-related preferences (e.g., when content items are to be received, a limit on a number of content items, a type of content item such as image or video, whether to accept sound-inclusive content items, size of screen, a number of current channel subscriptions, historical time in display mode, where the channel will be ranked amongst other channels, etc.), or other information.

In some embodiments, the subscription request may correspond to a user for one or more computing devices, rather than corresponding with a particular computing device. For example, the server may associate a user identifier dynamically with a computing device (e.g., through providing authentication credentials to a login webpage). The server may determine the type of computing device that the user is operating at the time (e.g., by interacting with the device, by requesting information from the user) and provide content item(s) to the computing device based in part on the dynamic determination of the computing device.

The computing device may send the subscription request to a server. The computing device accesses an application (e.g., a web browser, a software “app” on a mobile device) to communicate with one or more servers via the network to submit the subscription request. The application can present a form (e.g., via an application programming interface (API)) or similar type of graphical user interface (GUI) to accept user input that is relevant to the one or more content items. The user may interact with the application and prompt a generation of a subscription request that includes the information. The subscription request can be transmitted to the server via a network (e.g., the Internet). In other examples, the user can send a communication message (e.g., email, phone call) that includes the relevant information, which the server can analyze (e.g., parse, store).

At complimentary block 210, a server receives the transmitted subscription request. For example, the server may receive the completed form from the software application at the computing device and store the information in a data store (e.g., for future use).

In some embodiments, the server may establish one or more rules corresponding with the subscription request. For example, when the subscription request includes a request for weather information when the device enters an idle state, the server may generate a rule that will be activated when an event notification is received that identifies that the device has entered an idle and/or display state. The rule can include establishing a connection to initiate a transmission of content item(s) via a channel, transmitting the content items, or any other commands that may be activated based in part on the subscription request.

At block 215, the server detects an event corresponding to entry into a channel state. The event may include an indication of a changed status at a computing device. For example, the event may include an indication that the computing device has access to the network and can accept content from the content delivery/receiving server 120. The communication can be received at the server from the computing device upon entry into display mode, during display mode, upon entry into a channel mode, during channel mode, after a certain amount of time (e.g., a reoccurring event every hour), upon receipt of a subscription request, or other communications that would notify the server of such an event.

The event may also or alternatively include an indication that a new content item was created, received or uploaded for a channel. For example, a publisher can provide (e.g., upload) a new content item to a server and/or data storage. The server may receive a notification that the content item(s) is available for transmission and/or placement into a channel. In other examples, the content item(s) can correlate with webpage content, such that the event can be identified when the webpage content changes and/or new webpage content is added. The server may incorporate the new webpage content with the channel.

In some embodiments, the event includes a notification of a temporal event. A temporal event can include a particular time during a day/week (e.g., at midnight each night). In some examples, the temporal event is the time between when the content item is received at a computing device (e.g., updated once per day) and the current time, the time a channel is updated (e.g., updated every hour), the moment a bill or subscription fee is paid, or other events that may correspond with a particular time or interval.

The event may also or alternatively include a notification that a subscription has been received. For example, the detected event may include a notification that a subscription request form was accessed or completed by a user operating the computing device, a computing device provided credentials to access a user account, the computing device completed a registration process to receive content item(s) from the server, and other similar subscription events.

At block 220, the server transmits the content item(s). For example, the content delivery/receiving server 120 can receive content items from a publishing server 110 and transmit the content item(s) to a computing device. The transmitted content items may include all content items associated with a particular channel, a subset of the content items in a channel, only new content items, recently submitted content items (e.g., associated with a particular fixed time period, a publisher-defined time period, a user-defined time period), or a specific number of content items (e.g., fixed or defined by a publisher/user).

In some embodiments, the server may maintain a record of transmissions associated with content items. For example, the server can review the record to determine when a content item was received from a publisher and/or when the server transmitted the content item to the computing device. The record may be associated with an identifier for the content item (e.g., content item #100 was transmitted January 2 at 1:00 PM to device #200). The server may analyze the record before transmitting the content items to the computing device and/or limit the transmissions based in part on the analysis (e.g., only transmit items to the device once per day).

In some embodiments, the computing device may be associated with user preferences, and the server may identify the preferences before transmitting the content item(s). For example, a computing device may identify that a particular user does not want to receive football scores at a work computing device, may identify that a user is not interested in promotion content items for a particular brand of item, or may not wish to receive video items. The server may analyze preferences for the computing device to determine which types of content items to send before the content item(s) are transmitted.

The transmission of the content item may include additional information associated with the content item, including an identification of a destination (e.g., URL or HTML identifier). In another instance and/or later in the process, upon receiving a selection of the content item by the computing device, the server may provide an identification of a destination. For example, the computing device can transmit a communication (e.g., including an identification of the content item) to the server. The server may respond to the communication with an identifier of the destination.

At block 225, the computing device receives the content item(s). In one embodiment, the content item(s) may be received by the computing device and/or saved at the computing device. When received, the content item(s) can be hidden from other programs behind active content. In some examples, active content may include one or more software applications that the user is interacting with on the computing device. In other examples, the active content may include a default screen (e.g., desktop) or background.

In some embodiments, the content items are stored in a data store (e.g., while the active content is displayed and the content items are hidden). For example, the data store can include a particular file structure to store and organize the content item(s) (e.g., by file name, date, size, file type, channel-type). In another example, the data store can include a single location (e.g., folder, hash table, queue, array, stack) where all content is stored. The content items may be sorted or retrieved dynamically from the data store. In yet another example, the data store can be a transitive data store where content items are stored temporarily (e.g., cache) and/or deleted after a determined amount of time.

In some embodiments, one or more content item(s) can be stored in association with one or more timestamps. For example, the timestamp can identify a time when the content item was transmitted to a computing device, a time that the content item was received or detected at the computing device, a time when the item was uploaded at a server from a publisher, a time when a content item was displayed by the computing device, or a time when a user interacted with a content item and visited a destination associated with the content item. In another example, a timestamp can be included with an identifier of a channel or other identifying information.

The content item(s) may include an association with an expiration time. The expiration time can be determined based in part on publisher input (e.g., allow use during life of a copyright or license, allow use for 1 month because the user paid for 1 month of use, remove the item when the item is no longer the latest product available), user preference (e.g., available during employment with a company, during a fantasy football league seasons, or during a holiday season or a promotional period), or fixed (e.g., expires after 1 week from transmission). The expiration of a content item can help ensure that the content items displayed at the computing device are relatively new and/or relevant to the user. The expiration of a content item may also affect local storage requirements by limiting the number or size of content item(s) stored at a computing device to a particular amount of storage available. In some embodiments, the expiration of a content item may be affected by a particular event at the computing device (e.g., remove content items when computing device is restarted). In some embodiments, the expiration of a content item may be based on an absolute time (e.g., December 31, the last day of the month), a time uploaded by the publisher, a time that is received from a third party, or a time that is received from the user (e.g., remove holiday content after January 1).

In some embodiments, the computing device may include remote updates by the content delivery/receiving server 120 without substantially interfering with the processing actively running on the computing device. For example, the server may have access to a portion of the memory at the computing device, so that the server may add or remove the information stored in the memory without interacting with or waiting for confirmation from the computing device that those items can be added or removed. In another example, the server may review central processing unit (CPU) usage or other resources at the computing device and update the content item(s) when a device is not using some portion of its resources (e.g., items removed when the computing device CPU is running at 5% usage).

At block 230, the computing device detects an event corresponding to entry into a display state. For example, when the event includes some predetermined amount of time and/or time period of inactivity at the computing device, the computing device may enter a display state. For example, the inactivity at a device could include a lack of interaction between a user and a computing device, including key strokes, cursor movements, selections, dragging, tapping, and/or clicks. In another example, the inactivity can include identifying when particular programs or software applications are not active (e.g., video conference call, teleconference call, streaming media) to help ensure that the device is idle or otherwise less used for a particular amount of time. In another example, an event corresponding to entry into a display state may be termination of a phone call on a mobile phone, or connection of a power charging device to a mobile computing device.

The predetermined amount of time of inactivity at the computing device can include a predetermined amount of time, such as 10 seconds, 30 seconds, 1 minute, 3 minutes or 1 hour. In some examples, the time period can be specified based on settings on the computing device (e.g., power-saving settings) or based on global or specific channel data (e.g., a server can define that the time period is 1 minute, or a user can enter input specifying a time after which channel content items should be displayed). In some examples, the predetermined amount of time can include the amount of time after an activity or event has ended (e.g., presentation of content items could begin after a call has ended on a mobile device).

In another example, the event can correspond to the user's request to enter a display state. In some embodiments, when the computing device is a desktop or similar device associated with a keyboard I/O device, the computing device may enter a display state in response to an interaction. For example, the interaction may include a selection of a predefined key, like an F10 key to enter the display state, and an F9 key to exit the display state. In some embodiments, the user may press Alt-Tab to activate a graphical user interface (GUI) that allows the user to provide commands to enter and ESC to exit the display state through the GUI.

At block 235, the computing device presents the content item(s). For example, the computing device may display the content item so that the content item is actively running on the computing device on top of the previously actively running application. The content item may be actively running when a content item is presented at the computing device. For example, the graphic, text, or series of graphics (e.g., in a video) can be presented on all or part of a display. When portions of the display are used to provide different content items at the same time, one or more of the portions of the display may provide one or more content items. When the content item includes sounds (e.g., an audio track, an audio/visual file), the sound can be output via a speaker at the computing device. In some examples, portions of the display at the computing device can be turned into a link area, such that an input corresponding to the area (e.g., a cursor click on the area) can cause destination information to be presented (e.g., an ecommerce page associated with the item presented as a content item). In some examples, user profile information can determine specific content presented to a user device. For example, a user may specify a number of companies' stocks in a profile of the user, which can cause the device to display these stocks' information in a channel. In another example, a fantasy sport user can specify, in a profile of the user, a number of football players to follow, which can cause the device to display channel content that includes these specific players' information.

The content item(s) provided by the channels may be shown sequentially, in a particular order, or based on a priority rating provided by the computing device (e.g., based in part on a playlist or instructions from a server, user, or computing device). For example, if a user is concurrently subscribed to two channels on one computing device, including a medicine channel that provides information on new drugs and clinical trials and a company event channel that provides information from a user's employer about new events provided by the company, the user may choose to show the content items associated with the medicine channel before the any content items associated with the company event channel.

In some embodiments, the computing device may determine which items to present. For example, upon detecting an event to visit a destination associated with a content, the computing device may access the stored location of the received content items and present (e.g., display on the entire screen or a portion of the screen associated with the computing device, play audio content items via a speaker) any received content items. The presented content items can include a sequential or interleaved presentation of all content items received from the server, all content items associated with a particular channel, a subset of the content items in one or more channels, only new content items (e.g., content items received in the most recent transmission), recently received content items (e.g., over the past day regardless of the number of content items received the most recent transmission), or a specific number of content items.

The determination of which content items to present can consider a variety of factors. For example, one or more channels may be ranked (e.g., based on the user's priority for viewing the content associated with the channel). The content items associated with a particular highly-ranked channel may be displayed before other channels that are not as highly-ranked. In another example, the content items within the channel may be ranked (e.g., based on the user's priority for viewing particular types of content within a particular channel, including weather content items before player statistic content items in a golf channel), and the content items associated with a particular high ranking in the channel may be displayed before other content items in the same or other channels that are not as highly-ranked.

In some embodiments, the determination of which content items to present can be based on a user's past interaction with the computing device. For example, a content item associated with women's shoes may be displayed and selected by the user, directing the computing device to access the destination associated with the content item to purchase the shoes (e.g., an ecommerce shopping webpage). The computing device can determine that the user is more interested in women's shoes than weather. In a subsequent presentation of content items, the content items associated with women's shoes, women's fashion, and/or another related topic can be ranked higher than other content items and displayed before other content items.

In some embodiments, the presenting of content items at the computing device can be associated with a temporal factor. For example, the temporal factor can include a time (e.g., an hour, minute, day, or date) at which the content item was uploaded to or otherwise received at the server (e.g., from a publisher), a time at which the content item was transmitted to or received at the computing device, a time at which the content item was displayed at the computing device, or the time at which the content item was transmitted from the server to the computing device. These times can be used (globally or within a channel) to, e.g., bias towards showing older content items first or showing newer content items first. In some examples, the higher-ranked content items may be presented in association with the time. In some examples, the content items can be presented in association with upcoming sales, events, or other specified times.

In some embodiments, the ranking of a content item can help determine other factors associated with presenting the content item. For example, the highly-ranked content items can include displaying or presenting the content item for one second longer than the content items that are not as highly ranked. In another example, the highly-ranked channels can include displaying the content item more than once (e.g., looped, repeated) before other channels are presented.

The determination of which content items to present may include a random selection and/or sequential ordering. For example, the content items may be presented in the order that the items were received from the server during the channel state (e.g., most recent items first). In another example, the content items may be presented based on alphabetical listing, identifier ordering, or purely random ordering.

In some embodiments, the server may determine which items to present (e.g., instead of the computing device). For example, the server may determine which content item to place first and for how long, determine which content item to place second, and transmit one or more content items based on the determination to the computing device. The server may also determine whether to loop items and/or the time duration to present the content items, so that the computing device merely presents the items in the order it is given by the server.

The computing device may present content items from a device playlist. A device playlist may include one or more identifiers, where an identifier can identify one or more content items received through a channel that are displayed by the computing device. For example, the playlist may include one identifier for a content item from the golf channel, two identifiers for two content items from a company events channel, and one identifier for a content item from an internal medicine channel.

In some embodiments, the device playlist may be identified before the computing device sends the subscription request to the server (block 205). For example, the computing device can identify identifier(s) for one or more channels to add to the playlist, identifier(s) for one or more types of content items in a channel, or identifier(s) for individual content items. The computing device may associate the channel, types of content items, or individual content items with a priority and/or ranking, so that particular content items or channels are presented more/less frequently, for a longer/shorter duration, at a particular time, etc. The identified priority and/or ranking of the channel, type of content item(s), or individual content items can be transmitted via a channel (block 220).

In some embodiments, the playlist may be generated, modified, or appended to an existing playlist. The server may include the new identifiers to the playlist intermittently or at a particular time (e.g., at the beginning, middle, end).

The playlist may be used to help determine which content items to present. For example, when using a playlist, if the play stops, the content items may resume at the same point in the playlist next time. In another example, when using a playlist, if the play stops, a new playlist may be generated and/or used.

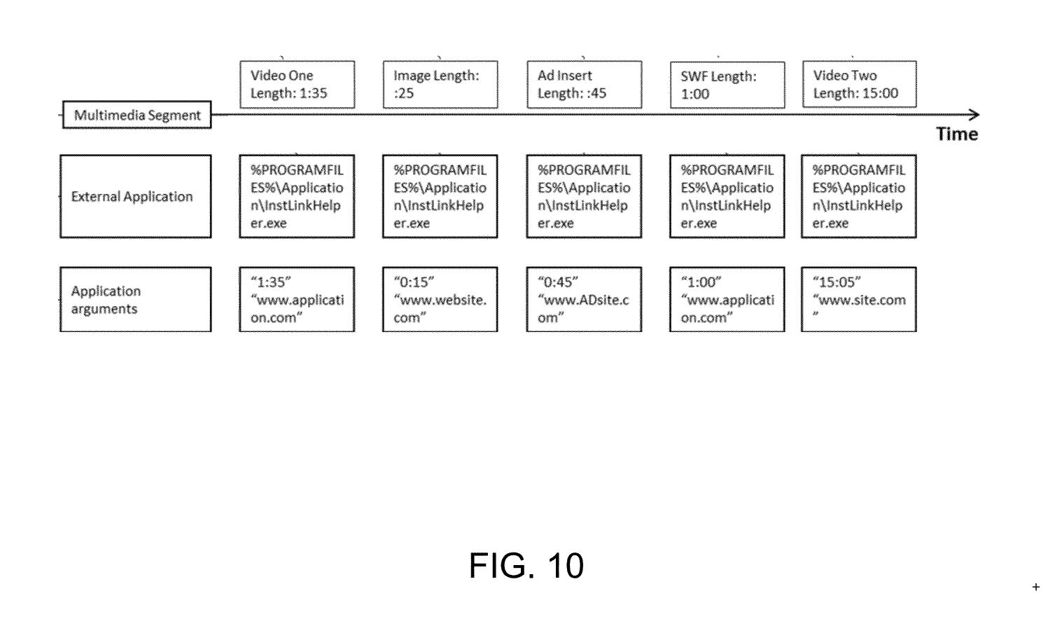

The playlist may also include playlist customization to define whether a particular channel or content item is active and/or associated with a priority (e.g., high/low priority, ordered priority) of the item, such that higher priority content items and/or channels may display before other content items and/or channels. Additional details and functions of the playlist can include those as discussed at greater length in reference to FIGS. 10-13.

Returning to block 235, the content item(s) can be presented for a particular duration. For example, when the content item is a video clip and/or audio segment, the content item can be presented for the duration of the video or audio segment (e.g., 5 seconds, 1 minute). The content item may be repeated or restricted to present the content item for more or less time than the full duration available as well. In another example, when the content item is a still image, the content item can be presented for a fixed duration determined by a publisher, server administrator, and/or user, or presented for a fixed duration time (e.g., all still images are presented for 10 seconds). In yet another example, the content item(s) are presented based in part on the ranking of the content item(s) or channels, so that the higher-ranked content items or channels are presented for a longer or dynamic duration in comparison to the lower-ranked content items or channels.

The duration may be affected by the amount of text or information displayed by the content item. For example, when the content item displays more than 100 words of text, the content item may be displayed for at least 30 seconds so that the user can have time to review (e.g., read, comprehend) the text presented.

In some instances, a displayed content item can be saved to a user device (e.g., into a file folder), such that the content item can be subsequently retrieved locally at the device. Such saving can occur in response to a user action (e.g., a click of a particular button or touching a screen). In some instances, a publisher can specify content items for which saving is to automatically occur and/or for which saving is to be allowed. Saving a content item can be of particular interest, e.g., when a content item includes a promotion or discount. A user can then retrieve the item to review promotion details and/or use the discount. For example, a user can indicate that a content item with a discount coupon for a restaurant is to be saved. When the user later visits the restaurant, the saved item can be automatically retrieved (e.g., in response to detecting that a device of the user is geographically near the restaurant) or retrieved upon user request to redeem the discount. A user device can report the information associated with the saving, retrieving and/or redeeming actions to server 110 and/or 120. The information can include times of the saving, retrieving and/or redeeming.

In yet another embodiment of the invention, a user can send a saved content item to another person (e.g., to refer that person to this restaurant). A user device can track the activities associated to the referral (e.g., such that a user can be credited with the referral or such that a publisher can be informed as to an occurrence of the referral).

In some embodiments, one or more reward points can be assigned to activities of a user. Reward points can be associated with a specific channel or a group (e.g., all) of channels. Whether reward points are awarded and/or a quantity of reward points awarded can be based on an amount of time displaying channel content, a number of interactions with the displayed content (e.g., requesting a destination, saving a content item, and/or sending a content item to another user), a number of content destinations visited, a frequency of referring content to others, a number of other users invited by the user to a channel or to a channel-viewing application, etc. The reward points can be updated and periodically displayed on a screen of a user device and a user web portal. Reward points can be redeemed, e.g., online or offline for discounted or free products and services. In cases of online product advertising displayed on user computing device, a server can collect information associated with user activities and purchases as a result of user exposure to displayed adverting through data from sources such as the API's from destination websites. This information can be sent (in a user-specific or user-aggregated manner) to a publisher.

In some embodiments, the computing device may present more than one content item at a time. For example, the computing device may show a first content item in the upper right-hand corner of the screen, a second item in the lower-right hand corner of the screen, and a third content item along the left-hand side of the screen. The computing device or server may determine where content items are placed (e.g., based in part on priority, channel affiliation, the timestamp of when the transmission was received from the server, timestamp of when the content item was received from a publisher). In other embodiments, the computing device will present one content item at a time (e.g., one visual image content item on the screen, one audio content item played via speakers at the computing device).

In some embodiments, the computing device may present additional information with the content item. The additional information may identify the source information of the content item (e.g., publisher, timestamp), explicitly identify a destination associated with the content item (e.g., the location on a network page that is provided when the computing device interacts with a content item), channel information (e.g., publishers, subscribers, last updated information), or other relevant information. The information may be presented in a layered format on top of the content item on the display, next to the content item, overlapping with the content item, interleaved with the content item presentation, or otherwise organized by the computing device and/or server.

At block 240, the computing device reports the occurrence of content-item presentation to the server. The report can include any metrics associated with the channel state and/or display state at the computing device. The report can identify information for the content-item presentation, including the computing device that received the content items during the channel state, the computing device that presented the content items during the display state, an identifier of a presented content item, a channel, any interaction (e.g., whether a destination was visited, whether the visit tied to a purchase), a total time in a display-mode session, or other relevant information for a publisher and/or server. The report can be transmitted to a server and/or publisher after presentation of each content item, at routine intervals, or at an end of a display state.

At block 245, the computing device stores data characterizing the presentation of the content item(s). This stored data can immediately or subsequently be used by the server or another device (e.g., having received the data from the server). A data can include a number of times a content item was displayed, a number of times content from a particular channel was displayed, the duration that a content item/channel was displayed, whether users selected an identifier of a destination, or whether users purchased items subsequent to presentation of the content item.

In some embodiments, the server may use the data to identify patterns, statistics, and/or reports. For example, the data can generate one or more new statistics and/or modify one or more existing statistics (e.g., to increment a count) based in part on the content-item presentation, including statistics for a given channel or content item. The patterns, statistics, and/or reports can also be stored with the original data.

At block 250, the computing device determines whether a second event corresponding to the end of the display state is detected. For example, the computing device may no longer be inactive. The event may include, for example, a keystroke, cursor movement, voice command, selection of a content item that directs the computing device to a destination, or a pre-determined amount of time. In some embodiments, for example, the computing device ceases display of the content item when an interaction with the content item at the computing device causes the information from the destination to be sent to the computing device. The computing device may be directed to the destination (e.g., a browser application may provide a network page associated with the content item to provide more information about the item). If the second event is not detected, the process may return to block 235, such that another content item can be displayed. If the second event is detected, the process may proceed to block 255.

At block 255, in response to the detection of the second event, the computing device ceases display of the content item(s). In some embodiments, the content items are, at least temporarily, no longer displayed on a screen of the computing device, audio is no longer played by the computing device speakers, and other forms of presentation are terminated. In some embodiments, the computing device can return to block 225 to receive one or more new content items or return to block 230 to detect an event corresponding to the entry into a display state.

It will be appreciated that the order of blocks in process 200 is illustrative, and alternative orders are contemplated. For example, block 230 may occur before blocks 220 and 225. In another example, blocks 240 and/or 245 may occur after blocks 250 and/or 255. In one embodiment, this order may allow content items to be effectively streamed, which can reduce or eliminate local storing of content items on the computing device. In other embodiments, the content items are still locally stored, but the order can improve the probability that the stored content items will be displayed and/or recent.

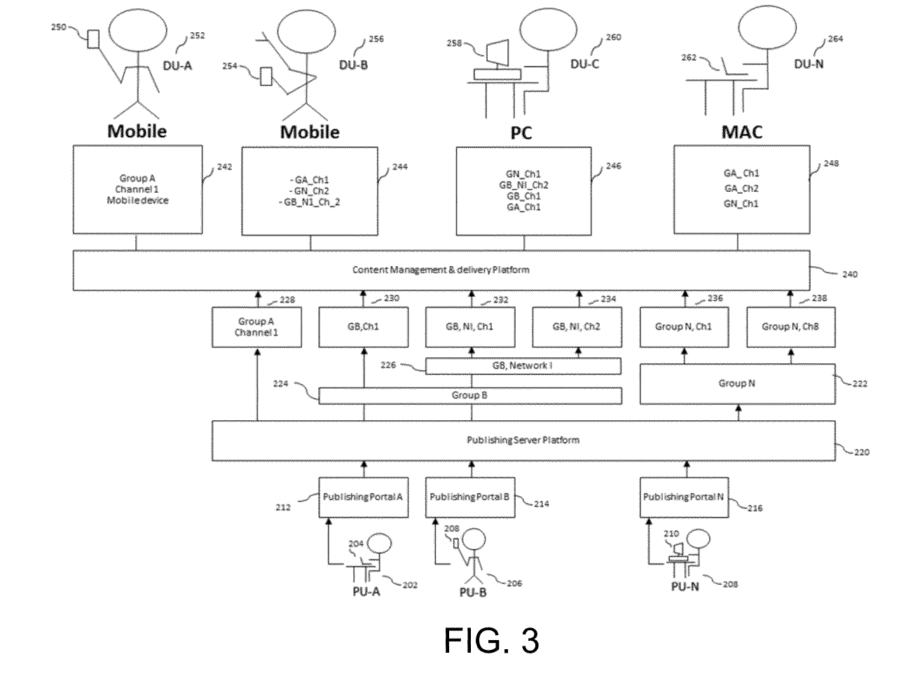

FIG. 3 shows a block diagram illustrating a system of providing dynamic content transmissions according to an embodiment of the present invention. The system can include one or more publishing servers, content delivery/receiving servers, content-creation computing devices, and content-display computing devices.

The one or more content-creation computing devices can access the one or more publishing servers through one or more publishing portals. The one or more publishing portals can include computer-readable media and instructions to determine information about the content-creation computing device accessing the publishing portal, the user operating the content-creation computing device, or related information for the user and/or computing device (e.g., correlated groups, content items, playlists, subscription requests). In some embodiments, the one or more publishing portals can be a web-based graphical user interface (GUI) or a mobile-based GUI.

A publishing portal can receive credentials (e.g., user name, login information, password, shared key, internet protocol (IP) address, approved computing device identifier) from the computing device and/or authenticate the computing device. In some embodiments, the content-creation computing device can actively provide the information (e.g., by typing, tapping, directing on a screen, or speaking the information into a microphone) or passively provide the information (e.g., by providing an IP address in response to a request from the publishing portal).

The content-creation computing device can provide (e.g., upload, save, identify) content items via the one or more publishing portals. In some embodiments, content items from more than one content-creation computing device (e.g., data feeds) can be used to generate a channel. For example, in a fantasy-sports channel, one content-creation computing device can provide pictures of players, one content-creation computing device can provide scores, and one content-creation computing device can provide injury reports. The information from each of those sources may be assembled as potential content items for the fantasy-sports channel.

The content-creation computing device can identify one or more groups and/or one or more channels for the content at the publishing server. In some embodiments, the information available at the publishing server can automatically identify groups of users, computing devices, content items, channels, or other information.

In some embodiments, the one or more groups may be identified by a particular geographic location. For example, a first computing device and a second computing device may request substantially identical content items and/or channels, but the first computing device is associated to USA and the second computing device is associated to Canada. In this example, the first computing device may be included in a first group and the second computing device can be included in a second group, even though each group may request substantially similar content items. In another example, the computing devices associated with two groups may request the same images and text, but the language of the text included with the content item(s) may be altered to satisfy a dominate language and/or the user's preferred language based in part on the geographic location.

The content-creation computing device can also use the one or more publishing servers to generate a request to join (e.g., subscribe to, submit a subscription request) a channel for one or more content-display computing devices. The request can include recommendations for one or more particular channels, including information about the channel (e.g., title, sample content items) for the one or more content-display computing devices to accept or reject.

The recommendations for a particular channel can be based on a variety of factors. For example, the recommendation can be based in part on a content-display computing device's past history (e.g., subscription, destination access), past preferences (e.g., priorities, playlists), likes/dislikes, explicit searches (e.g., received prior to a subscription request), or location-based searches (e.g., zip code of the location of a computing device, address of a user, identification of nearby stores to a user that provide content items).

After the groups, content, channels, or other information has been initially identified, the content delivery/receiving servers can prepare the content for delivery. For example, one or more content items can be prepared for the computing devices that are mobile devices associated with Group A and Channel 1. The content items may include images, videos, audio, text, or other information particularly formatted or optimized for mobile devices. In another example, one or more content items can be prepared for the computing devices that are desktop computers associated with Group A and Channel 1. It should be appreciated that any combination of computing device, group, and channel can be created.

The content-display computing devices can receive the content items from the content delivery/receiving servers. For example, the content-display computing devices can receive the content items when the content-display computing device is in a channel state and/or available to accept the content items from the content delivery/receiving servers.

The content-display computing devices can display the content items when the content-display computing device is in a display state and/or available to provide the content items. For example, the computing device may enter into a display state after some predetermined amount of time and/or time period of inactivity (e.g., lack of interaction between a user and a computing device, identifying that particular programs or software applications is not active).

FIG. 4 illustrates an example architecture for one or more servers in the dynamic content transmission system, including a publishing server 110 and a content delivery/receiving server 120, according to an embodiment of the present invention. The publishing server 110 and a content delivery/receiving server 120 (hereinafter “Servers”) may communicate directly (e.g., wired or wireless connection) or through a network 130. In some embodiments, the servers may be implemented as a single server computer (as illustrated by the dashed box) or multiple servers.

In one illustrative configuration, the servers may include at least one memory 410 (herein shown as 410-A and 410-B) and one or more processing units (or processor(s)) 424 (herein shown as 424-A and 424-B). The processor(s) 424 may be implemented as appropriate in hardware, computer-executable instructions, firmware, or combinations thereof. Computer-executable instruction or firmware implementations of the processor(s) may include computer-executable or machine-executable instructions written in any suitable programming language to perform the various functions described.

The servers may also include computer-readable non-transitory media 410, including memory and/or additional storage. For example, the computer-readable non-transitory media may include volatile or non-volatile, removable or non-removable media implemented in any method or technology for storage of information such as computer-readable instructions, data structures, program modules, or other data. The computer-readable non-transitory media may store program instructions that are loadable and executable on the processor(s), as well as data generated during the execution of these programs. The computer-readable non-transitory media may be volatile (such as RAM) and/or non-volatile (such as ROM, flash memory, etc.). The servers may also include additional storage, which may include removable storage and/or non-removable storage. The additional storage may include, but is not limited to, magnetic storage, optical disks and/or tape storage. The disk drives and their associated computer-readable non-transitory media may provide non-volatile storage of computer-readable instructions, data structures, program modules and other data for the computing devices. In some implementations, the memory may include multiple different types of memory, such as SRAM, DRAM, or ROM.

Turning to the contents of the publishing server 110 memory in more detail, the memory may include an operating system, one or more data stores, and/or one or more application programs or services for implementing the features disclosed herein, including a grouping module 414, channel module 416, content module 418, user module 420, and/or destination module 422.

In some examples, the grouping module 414 may be configured to determine a group of one or more computing devices, including one or more mobile computing devices and/or desktop computing devices, for receiving a channel. For example, the computing devices for a particular organization may be included in a group. In another example, each computing device that has submitted a subscription request to receive a particular channel may be included in a group. In another example, each computing device in a region that runs a particular operating system may be included in a group.

The grouping module 414 may also be configured to correlate one or more computing devices with information included with a subscription request. For example, the server may receive the subscription request from a computing device, determine other computing devices that are associated with substantially similar subscription requests and/or rules resulting from a subscription request, and associate similar users or devices with a group when those users or devices can receive similar content item(s). The server may determine the type of computing device that the user is operating at the time (e.g., by interacting with the device, by requesting information from the user) and provide content item(s) to the computing device based in part on the dynamic determination of the computing device.

In some examples, the channel module 416 may be configured to generate a channel. The channel can be a pipeline between a server and computing device that provides one or more content items. In some embodiments, the channel may be associated with a unique name, so that the users can search for a particular channel and/or receive all or part of the content items associated with the particular channel.

The channel module 416 may also be configured to manage a payment associated with reserving a channel. For example, a content-creation computing device can provide a payment of fees (e.g., one-time, monthly, annually, for a particular duration) in order to have the opportunity to provide content for a particular channel. The payment may distinguish the amount of space, bandwidth, different levels of web hosting, or other features. A payment may also be received from a user operating a content-display computing device 150 for the opportunity to present one or more content items (e.g., fee-based presentation, free content, subscription-based).

The channel module 416 may also be configured to identify a computing device that is configured to display channel content. For example, the computing device may be associated with a subscription request that asks for particular content item(s). In another example, the computing device may include physical specifications to provide the content item(s) to a user, including a screen to display the one or more content items, a media card to process the video associated with the content item(s), or speakers to emit the sound associated with the audio-based content items. In yet another example, the channel module 416 can be configured to provide the content based on the type of computing device that will display the content item(s) (e.g., limit the content item(s) to particular dimensions for a mobile device, limit the content item(s) to a particular file type for a Microsoft® Windows® operating system). In some embodiments, the server may deliver the content item(s) without identifying the specifications of the computing device.

The channel module 416 may also be configured to identify a channel that is associated with the computing device. For example, the computing device may have submitted a subscription request to a server, the server may have associated a rule with the computing device, or any other methods of identifying a computing device that is configured to display channel content.

The channel module 416 may also be configured to detect an event corresponding to entry into a channel state. The event may include an indication of a changed status at a computing device. For example, the event may include an indication that the computing device has access to the network and can accept content from the content delivery/receiving server 120. The communication can be received at the server from the computing device upon entry into display mode, during display mode, upon entry into a channel mode, during channel mode, after a certain amount of time (e.g., a reoccurring event every hour), upon receipt of a subscription request, or other communications that would notify the server of such an event.

In some examples, the content module 418 may be configured to identify a content item that is associated with a channel. For example, the content item(s) may be received from a publisher, a content-creation computing device, or other source. The content item may be initially identified as a file name or link that the content module 418 can retrieve and use to create the content item. The content module 418 may also identify an initial duration to display the content item at the computing device.

The content module 418 may also be configured to determine one or more content items to transmit to a computing device. For example, a similar content item may be transmitted to all computing devices, a subset of all content items may be transmitted to all computing devices, or some portion of the content items may be transmitted to the computing devices in a group (e.g., determined by the grouping module 414).

The content module 418 may be also be configured to identify content items requested from a subscription request. The subscription request can be a message from a computing device that requests a transmission of one or more content items to the computing device. In a non-limiting example, content module 418 can aggregate user profile information to define a group to transmit an update of a specific football player. In another non-limiting example, the subscription request contains information that can identify content items, including information about the requester or request, including one or more identifiers of the user (e.g., name, email address, phone number), identifiers of the computing device (e.g., an IP address), identifiers of a type of device (e.g., mobile device, laptop, desktop, tablet or particular brand thereof), identifiers of the content item(s) and/or channel, operating system(s), channel-related preferences (e.g., when content items are to be received, a limit on a number of content items, a type of content item such as image or video, whether to accept sound-inclusive content items, size of screen, a number of current channel subscriptions, historical time in display mode, where the channel will be ranked amongst other channels, etc.), or other information.

The content module 418 may be also be configured to provide content based in part on the event detected at the computing device. For example, the event may include an indication that the computing device has access to the network and can accept content from the content delivery/receiving server 120. The content module 418 may be configured to interact with the channel module 416 (e.g., to provide content items for a particular channel) or the destination module 422 (e.g., to associate a destination with a particular content item). The content module 418 may be also be configured to provide the content to a content delivery/receiving server 120 via the delivery module 454 (e.g., to provide the content item via a channel to the computing device).

In some examples, the user module 420 may be configured to identify a user associated with a computing device. The identification can include a name, email, phone number, or particular access rights for the user and/or computing device (e.g., administrator, publisher, sales). For example, a user with sales access rights can review the content items, users, and/or computing devices for a group. In another example, a user with publisher access rights can submit content items for a group, remove content items for a group, and/or any access rights of a sales profile. In another example, a user with administrator access rights can add/remove users from a group, add/remove channels from the system, alter delivery information, alter display information, and/or any access rights of a sales or publisher profile.

The user module 420 may be also be configured to identify rules and/or playlists associated with a user. These rules and/or playlists can include ones determined at a server or computing device. For example, the subscription request received from a computing device may have requested weather information when the device enters an idle state. The user module may be configured to identify a weather rule and/or determine whether the computing device has entered the idle state. The user module 420 may interact with a delivery module 254 to establish a connection with the computing device to initiate a transmission of content item(s) via a channel, transmit the content items, or any other commands that may be activated based in part on the subscription request.

The user module 420 may be also be configured to ensure that a playlist is up-to-date for a particular computing device. For example, the user module 420 may be configured to determine a particular version, download date, or timestamp of a playlist, determine whether another playlist is available for the computing device, and/or update the playlist for a computing device, when applicable.

In some examples, the destination module 422 may be configured to identify a destination associated with the content item. In some examples, an interaction with the content item at the computing device can cause information from the destination to be sent to the computing device. In some examples, the destination module 422 can be configured to instantly display information from a destination such as a webpage or a file.

Turning to the contents of the content delivery/receiving server 120 memory in more detail, the memory may include an operating system, one or more data stores, and/or one or more application programs or services for implementing the features disclosed herein, including an delivery module 454, a receiving module 456, a device module 458, and/or a reporting module 460.

In some examples, the delivery module 454 may be configured to transmit the content item(s) to a computing device. For example, transmission may include accessing a network 130 via a particular protocol (e.g., transmission control protocol (TCP)) to transmit packets, information, or other formatted data to the computing device. In some embodiments, the delivery module 454 can be configured to receive content items from a publishing server 110 (e.g., via the content module 418) and transmit the content item(s) to a computing device. The transmitted content items may include all content items associated with a particular channel, a subset of the content items in a channel, only new content items, recently submitted content items (e.g., associated with a particular fixed time period, a publisher-defined time period, a user-defined time period), or a specific number of content items (e.g., fixed or defined by a publisher/user).

The delivery module 454 can also be configured to associate user preferences with a computing device before transmitting the content item(s). For example, a computing device may identify that a particular user does not want to receive football scores at a work computing device, may identify that a user is not interested in promotion content items for a particular brand of item, or may not wish to receive video items. The delivery module 454 may be configured to analyze preferences for the computing device to determine which types of content items to send before the content item(s) are transmitted.

The delivery module 454 can also be configured to maintain a record of transmissions. For example, the record of transmissions can be associated with content items. The delivery module 454 can review the record to determine when a content item was received from a publisher and/or when the content item was transmitted to the computing device. The record may be associated with an identifier for the content item (e.g., content item #100 was transmitted January 2 at 1:00 PM to device #200). The delivery module 454 may analyze the record before transmitting the content items to the computing device and/or limit the transmissions based in part on the analysis (e.g., only transmit items to the device once per day).

The delivery module 454 can also be configured to include additional information with the transmission of the content item. For example, the additional information can include an identification of a destination (e.g., HTML identifier). In another instance and/or later in the process, upon receiving a selection of the content item by the computing device, the delivery module 454 may provide an identification of a destination (e.g., via an interaction with the destination module 422). For example, the computing device can transmit a communication (e.g., including an identification of the content item) to the delivery module 454 and the delivery module 454 may respond to the communication with an identifier of the destination.

In some examples, the receiving module 456 may be configured to receive the transmitted subscription request. For example, the server may receive the completed form from the software application at the computing device and store the information in a data store (e.g., for future use).

The receiving module 454 can also be configured to establish one or more rules corresponding with the subscription request. For example, when the subscription request includes a request for weather information when the device enters an idle state, the receiving module 454 may generate (e.g., or interact with the user module 420 to help generate) a rule that will be activated when an event notification is received that identifies that the computing device has entered an idle state. The rule can include establishing a connection to initiate a transmission of content item(s) via a channel, transmitting the content items, or any other commands that may be activated based in part on the subscription request.

In some examples, the device module 458 may be configured to detect an event at the computing device (e.g., entry into a channel state, entry into display state) and/or a changed status at a computing device. For example, the event may include an indication that the computing device has access to the network and can accept content. In another example, the event may include an indication that the computing device has entered a display state, is about to enter a display state, has been in a display state for a particular amount of time, or is exiting a display state.

The device module 458 may also be configured to receive an indication that a new content item was created, received, or uploaded for a channel (e.g., via a content-creation computing device 140) and correlate the status of the computing device with the delivery of the content (e.g., while the computing device is in a channel state). For example, a publisher can provide (e.g., upload) a new content item to a server and/or data store. The device module 458 may receive a notification that the content item(s) is available for transmission and/or placement into a channel. In other examples, the content item(s) can correlate with webpage content, such that the event can be identified when the webpage content changes and/or new webpage content is added. The server may incorporate the new webpage content with the channel.

In some examples, the reporting module 460 may be configured to store data characterizing the presentation of the content item(s) (for a single user device or across multiple user devices). This stored data can immediately or subsequently be used by the server or another device (e.g., having received the data from the server). Data can include a number of times a content item was displayed, a number of times content from a particular channel was displayed, the duration that a content item/channel was displayed, whether users selected an identifier of a destination, whether users purchased items subsequent to presentation of the content item, or other relevant information.

The reporting module 460 may also be configured to identify patterns, statistics, and/or reports. For example, the data can generate one or more new statistics and/or modify one or more existing statistics (e.g., to increment a count) based in part on the content-item presentation, including statistics for a given channel or content item. The patterns, statistics, and/or reports can also be stored with the original data.

The servers may also include one or more I/O (input/output) devices 426 (herein shown as 426-A and 426-B), such as a keyboard, a mouse, a pen, a voice input device, a touch input device, a display, speakers, a printer, and the like.

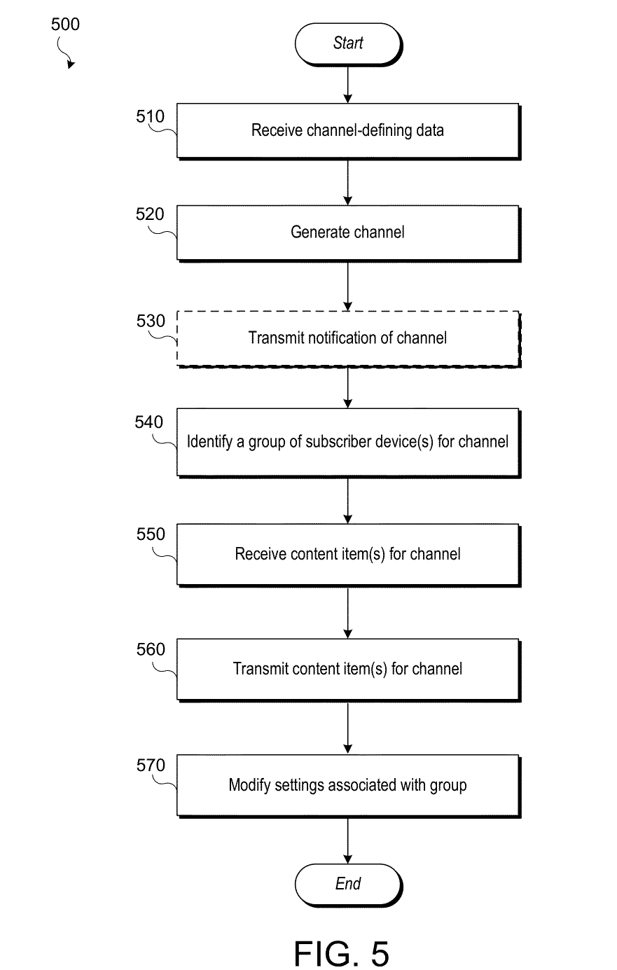

FIG. 5 illustrates an example flow diagram of a process 500 for transmitting content to a computing device according to an embodiment of the present invention. In some examples, one or more servers, such as the publishing server 110 (e.g., utilizing at least one of the grouping module 414, channel module 416, content module 418, user module 420, and/or destination module 422) and/or a content delivery/receiving server 120 (e.g., utilizing at least one of the delivery module 454, a receiving module 456, a device module 458, and/or a reporting module 460) shown in FIG. 4 may perform the process 500 of FIG. 5.

The process 500 may begin at block 510 by receiving channel-defining data. For example, the channel-defining data can be provided by a publisher (e.g., operating a publishing server 110, operating a content-creation computing device 140). The publisher can enter channel-defining data (e.g., at an interface provided by publishing server 110) about which channel-defining data the users may search for in order to request a new channel and/or content items provided via a channel (e.g., at an interface provided by content delivery/receiving server 120).

The channel-defining data can include various information about a channel. For example, the channel-defining data can include information to initiate a channel, including a title (e.g., “Golf” or a brand name like Macy's®), a generic description of content items provided by the channel, a description of the content provider, one or more examples of the types of content items that are available on the channel, metadata, or keywords (e.g., to assist with a text-based search of channels). In some examples, the channel-defining data can include an identification of one or more users who can submit content for the channel or a frequency at which new content is to be added to the channel. In some examples, the channel-defining data can include which users can subscribe to the channel (e.g., all users, a list of specific users, all users except those on a black-list), the cost of a channel (e.g., available for free or for a fee), or any rewards/loyalty points earned by viewing the channel.

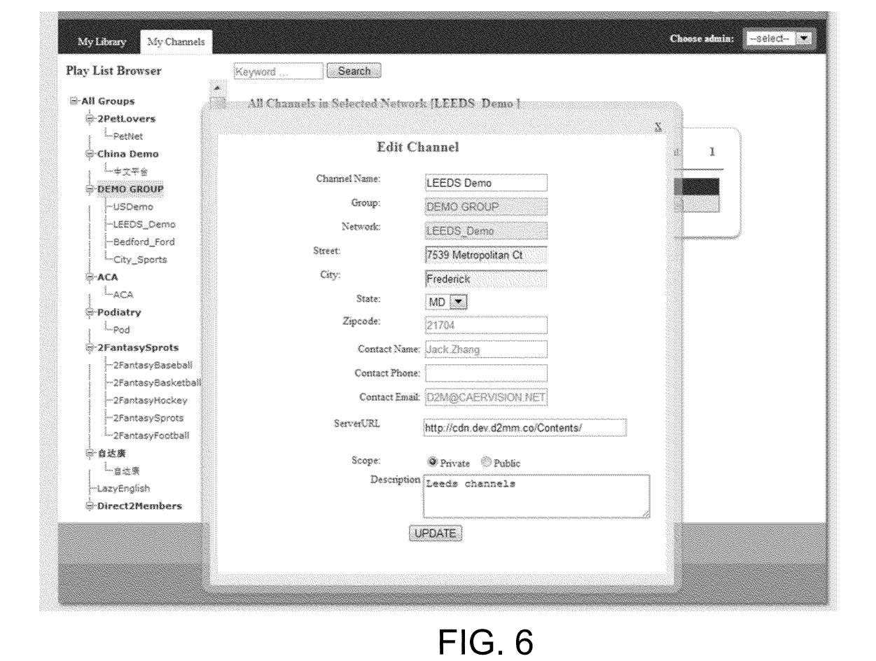

An example of a graphical user interface (GUI) that is used to receive channel-defining data is shown in FIG. 6. FIG. 6 shows an illustration of a graphical user interface for editing a channel according to an embodiment of the present invention. As shown, the GUI can include one or more text boxes to accept information. Alternative GUI input-receiving elements can include, e.g., a list of radio elements or a drop-down menu. The input-receiving elements may receive input for, e.g., a channel name, group, publisher's contact information, accessibility of the channel (e.g., whether it is to be searchable such that the channel is to be identified to members of the public responsive to a query or private), a description of the channel, or other information. In some embodiments, the information provided in the GUI may be pre-populated so that the publisher can update the information previously related with the channel.

In some embodiments, channel-defining information can include identification of one or more users. For example, the channel-defining information can identify information for a particular user and/or computing device (e.g., name, user name, identifier, email address, phone number). The channel-defining information may also identify that a user is associated with one or more groups (e.g., all mobile devices in the U.S. that subscribe to the Golf Channel, all desktop computers in the U.S. that subscribe to the Acme Co. Channel). In some embodiments, channel-defining information can associate information with the publisher-side of a channel, so that a publisher, content provider, and/or administrator can manage the channel-defining information based in part on access rights.

The channel-defining information may also include a role and/or authorization of the user associated with particular access rights (e.g., administrator, publisher, sales). For example, a user with sales access rights can review the content items, users, and/or computing devices for a group, a user with publisher access rights can submit content items for a group, remove content items for a group, and a user with administrator access rights can add/remove users from a group, add/remove channels from the system, alter delivery information, alter display information. In some examples, one or more groups may share access rights (e.g., both administrators and publishers may submit content).

In some embodiments, the channel-defining information may be accessible via a user interface (e.g., GUI) at the publishing server and/or content delivery/receiving server. The GUI may also provide functionality for a user with administrator access rights to add/remove/alter access rights of other users (e.g., changing user A from sales access rights to publisher access rights).

Returning to FIG. 5 at block 520, the process 500 includes generating a channel. The channel may establish a pipeline between a server and computing device that provides one or more content items. Upon generation, the channel can be configured accept new content items (e.g., from a publisher or from a location identified by a publisher) and to transmit the content items to one or more computing devices.

At block 530, the process 500 includes transmitting a notification of the channel. In some embodiments, block 530 may be optional, such that a notification of a channel will not be transmitted. In some embodiments, the notification of the channel may be a transmission that includes information about the channel and/or can include information corresponding to channel-defining information received at block 510. For example, the notification of the channel may include the title of the channel, one or more keywords of the channel, a brief description of the channel, sample content items included in the channel, expected frequency of transmissions content items in the channel (e.g., when new content items are provided to the computing device), frequency of updates (e.g., when new content items are provided by publishers to update content available in a channel), identifications of one or more affiliated users, publishers that provided content items, or other information that may be useful for a user.

The method of transmission may vary. For example, when the computing device has access to a software application (e.g., a software “app” on a mobile device), the app may notify the computing device by an icon, flashing notification, or other indication that the app has received an update. In some examples, the computing device may receive a message (e.g., email, text, short message service (SMS), voice message, push notification) that the user can access to receive the notification that a channel is available. In some examples, the user may browse to a webpage and/or data store to view, search, query, explore, or otherwise find a listing of channels.

The transmission may be provided at various intervals. For example, transmitting the notification can occur automatically (e.g., daily, monthly, every-other Tuesday), upon request (e.g., filling out a request to receive reoccurring or one-time notifications), after a search for a channel has been initiated (e.g., search for “golf” and receive a notification that includes all “golf” channels, after a search for a term that corresponds to the channel's title, keyword, or description), after a channel has been generated (e.g., by a publisher), after a channel has been identified as a public channel (e.g., by a publisher), or other times. Thus, it will be appreciated that, in various embodiments, multiple users may be notified of a given channel simultaneously or at different times.

In some instances, information about the channel can be presented along with an option to subscribe for the channel (e.g., by submitting a subscription request). The information can also indicate whether a fee is due for subscribing to the channel.

At block 540, the process 500 includes identifying a group of subscriber device(s) for the channel. Each device in the group of subscriber devices can correspond to a user who subscribed to the channel. A given subscribing user may correspond to one or more subscriber devices. It will be appreciated that the group can be dynamic, such that devices are added or deleted from the group as corresponding users subscribe or unsubscribe to the channel.

A particular subscriber device (e.g., computing device) in the group may be may be identified. In some embodiments, the user can explicitly identify one or more devices in a subscription request that should receive one or more content items. The request may include the computing device internet protocol (IP) address, a device name, or other information that may identify a particular device by a user. For example, a user can access a profile while operating a first computing device in the morning to submit a subscription request for a new channel. Later the same day, the user may access his profile while operating a second computing device. The user may choose to restrict the golf channel from the second computing device and/or add the same channel to the first computing device. In some embodiments, the user may be associated with two different groups (e.g., one group for the first device and one group for the second device).

In another example, the user may operate one computing device, but provide various identifiers (e.g., user identifier, device identifier, IP address) and/or authentication credentials to operate the device. Each identifier may be associated with a particular group, so that when the user provides a first identifier, a first set of content items are provided, and when the user provides a second identifier, a second set of content items are provided.

In some embodiments, the server may detect which device is sending the subscription request and associate the content item(s) requested through the subscription request with the device that requested them. In some embodiments, the server may detect which device is operational when a user logs into an account, provided credentials for authentication, passively interacts with the server (e.g., cookies, IP address), or other methods of detection.

At block 550, the process 500 includes receiving content item(s) for the channel. For example, the content item may be received from a publisher, a data store, or other source. In another example, the content item can be provided to one or more computing devices at substantially the same time.

The content item(s) may be associated with each subscriber device in the group of subscriber device(s). For example, the subscriber device may be a content-display computing device enabled to display one or more content item(s). The publisher can further or alternatively identify content items (e.g., images or videos) for the channel. In one instance, the publisher can upload (at one or multiple times) one or more content items (e.g., images identifying results of recent golf tournaments, videos promoting sales on golf clubs, text about golfers, or text and images identifying weather conditions at nearby golf courses) to a server. In an alternative or additional instance, the publisher can identify a content source (e.g., a webpage) and/or destination.

At block 560, at least one of the received content items is transmitted to at least one of the subscriber devices. In one embodiment, all received content items are transmitted to all subscriber devices. In one embodiment, only a portion of the received content items is transmitted. The portion can include a fixed number of content items, content items matching a user's preferences, content items with dates meeting a criterion (e.g., pertaining to an upcoming event), and/or content items with a high transmission priority (e.g., identified by a publisher as being an item to push). In one embodiment the content item(s) are transmitted to only a portion of the subscribing users. The portion can be selected based on states of the users (e.g., only sending content items to those users entering a display state), a preference of the users (e.g., only sending content items to those users with a “content-push” preference), channel content items already on the users' devices (e.g., to keep a number or size of cross-channel or channel-specific content items below a threshold), and/or a channel access characteristic of users (e.g., biasing transmission towards users/devices with frequent access or recent access of channels or of a specific channel). Thus, it will be appreciated that, in various embodiments, a given channel content item can be transmitted to multiple users simultaneously or at different times. It will also be appreciated that, as used herein, actions or conditions disclosed with reference to “a user” can alternatively or additionally apply to a user device.

The transmissions may occur at a triggered time. For example, one or more content items can be transmitted upon receipt of a new content item, receiving more than a threshold number of content items for a given channel or for a user (e.g., or computing device), identification that a subscriber device is about to enter or has entered a display mode, or a request from a subscriber device. In one instance, a server tracks an accumulation of new content items not yet transmitted to a particular computing device. Upon receiving an indication that the computing device has entered a display mode, it can push a particular number of these new content items (e.g., 10) every 5 minutes so long as the computing device remains in the display state.

It will be appreciated that process 500 can include a repetition of multiple blocks. For example, notifications of a channel be repeatedly transmitted (e.g., to new users, in response to new searches, etc.). As a group of subscriber devices can be dynamic, block 540 can be repeatedly performed. As another example, blocks 550-560 can be repeated as new content items are repeatedly received.

Upon collecting a group of content items, it can be important to sort these into an order. The order can be include an order for transmitting items from a server to a device (e.g., a precise order or a grouping of content items into batches for ordered transmission) and/or an order for displaying the content items on a computing device. In some instances, an order is determined for content items of a particular channel, and in some alternative or additional instances, an order is determined for cross-channel content items. The latter can include determining an order for channels (e.g., to thereby create a cross-channel content-item sequence by combining intra-channel sequences).

A playlist relates to a sequence for displaying a set of content items on one or more computing devices. Thus, the playlist can include a sequence (e.g., ordered list) and a set of content-item identifiers. The playlist can specifically identify content items or can more generally identify them (e.g., a “weather-update” content item for the Golf channel, or an “educational video clip” content item for a Math channel). In the latter instance, a computing device can use the playlist's constraint to select an appropriate content item (e.g., using a pseudo-random selection or by selecting a matching content item with the most recent publishing date). In some instances, the playlist further includes a duration (which may be the same for all content items, for all content items of a given type or all content items for a channel or which may be specific to a content item) for which a content item is to be displayed.

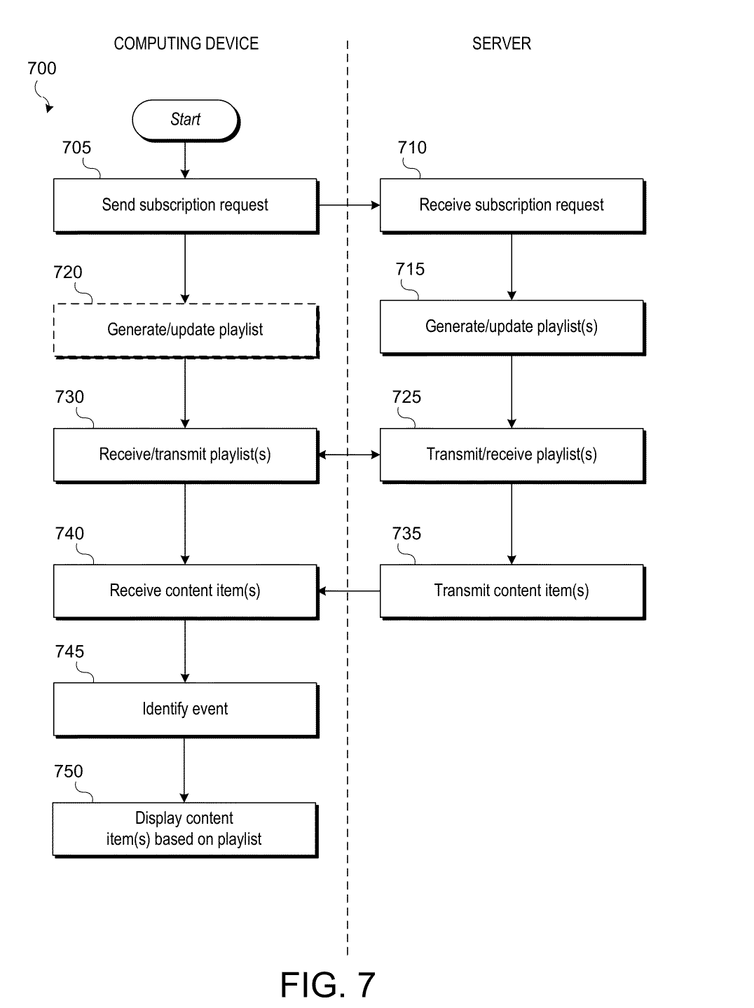

FIG. 7 illustrates an example flow diagram of a process 700 for generating and using a playlist according to an embodiment of the present invention. As shown, various portions of process 700 can be performed by a computing device (e.g., a content-creation computing device 140, a content-display computing device 150), and other portions can be performed by a server (e.g. a publishing server 110 and/or a content delivery/receiving server 120). Blocks 705 and 710 of process 700 can parallel blocks 205 and 210 of process 200.

At block 715, the server generates or updates a playlist, and at block 1020, the computing device generates or updates a playlist. The playlist generated or updated at blocks 715 and 720 can be the same or different. It will be appreciated that, in some embodiments, process 700 does not include block 715 or 720, such that management of a playlist is managed by a single device.

The playlist can be applicable to a specific channel and/or to a computing device/user. In the latter instance, the playlist can include a multi-channel sequence. Developing a user-specific playlist can utilize information corresponding to a particular user or device, such as which channels are subscribed to; a ranking of channels; preferences, restrictions or ranking of types of content items; a type of even that is to trigger channel content-item display; and/or inter- or intra-channel preferences or restrictions of content-item sequences. The playlist can further use information corresponding to a particular publisher. For example, a publisher may indicate that a given content item is to be presented before another content item, or a publisher may identify a proportion of time to be allocated to content items of given characteristics (e.g., spend 50% of the channel's time showing “clothing” content items; 20% for “shoes” content items and 30% for “jewelry” content items).

In one instance, multiple playlists influence a transmission or display order. For example, an intra-channel playlist can be generated for each channel, which identifies an order for content items of the channel to be transmitted or displayed. An inter-channel playlist can then identify an order for channels (e.g., channel 1 content item, channel 2 content item, channel 3 content item, channel 1 content item, channel 3 content item, etc.; or all of channel 1's content items, all of channel 2's content items, etc.). The lists can then be combined to identify a sequence of specific items.

A playlist may include one or more identifiers. Each identifier can identify a specific content item, a publisher, a type of content item and/or a channel. For example, the playlist may include one identifier for item ABC from the golf channel, a channel-specific identifier (not specifying a particular item but merely specifying the channel) for a company events channel, and one identifier for a graphic item from an internal medicine channel. In one instance, the playlist includes a single type of identifier (e.g., such that all identifiers are for specific content objects). In one instance, the playlist includes multiple types of identifiers.

Playlist generation can depend on which content items are active (e.g., such that an expiration date has not yet passed) and/or a publisher's or user's priorities. For example, a user can prioritize channels and/or types of content items. As another example, a publisher can indicate that content items are to be displayed in a particular order or an order corresponding to an upload date. As yet another example, a publisher can identify each of some or all of a set of content items for a channel as being of a particular priority level (low, medium or high). An order of the publisher's content items within a playlist can then accordingly reflect the priorities. As yet another example, a user or publisher can define target proportions for channel display. To illustrate, a user can indicate that 50% of channel-display time is to be devoted to Channel A, or a publisher can indicate that 25% of content items displayed for Channel A are to be news reports.

Blocks 725 and 730 are complementary, where the computing device or the server transmits part or all of the generated/updated playlist (or information about the playlist) to the other of the computing device or server, which then receives the transmitted data. In some instances, the communicated data identify a change to an existing playlist or inputs that prompted a generation or update of a playlist.

The communication can occur via a network (e.g., the Internet).). The transmitted data can include an electronic file recognizable by the receiving device (e.g., a text or proprietary file extension, including instructions for the presentation duration or destination of a content item), or a communication message (e.g., email, text message) that includes the relevant information. The receiving device can analyze (e.g., parse, store) the transmitted data in order to update a playlist or identify which content items are to be displayed. In some embodiments, the transmitting device and/or receiving device accesses an application (e.g., a web browser, a software “app” on a mobile device) to communicate with the other device via the network.

In some instances, the receiving device can use the transmitted data to update a locally stored playlist. Updating the playlist can include replacing the locally stored playlist with the playlist received from the server. Updating the playlist can alternatively include appending a stored playlist with the received playlist. In one instance, updating the playlist includes generating a new playlist. For example, a transmitted playlist can include a sequence of channel identifiers. The receiving device can then generate a playlist of content identifiers (e.g., by selecting using an order and/or pseudo-random process amongst content items for a channel) with the sequence of content items corresponding to the sequence of channels. As another example, the transmitted playlist can include a sequence of content items for a specific channel. The receiving device can then generate a playlist that includes the channel's sequence (e.g., as a blocked portion or interleaved throughout the sequence).

It will be appreciated that, in some instances, blocks 1025 and 1030 are omitted from process 1000. This can be appropriate in instances in which a single device manages and uses a playlist.

At block 735, the server transmits the content item(s). The server can transmit one or more content item(s) to the computing device via a network (e.g., the Internet). In some instances, which content items are transmitted and/or an order of the transmission it based on the playlist. For example, a transmission can be limited to only include content items identified in or matching part or all of a playlist, or an order of the transmission can correspond to a playlist order. Multiple content items can be transmitted individually or in one or more batches. One or both of the computing device and server can influence which content items are transmitted and/or an order of transmission (e.g., which can be influenced by batch assignments). For example, a computing device can request specific content items or a server can determine the transmission specifics locally. Which content items are transmitted can also be influenced based on information (stored at the server or stored at or determined by the computing device) indicating which content items are already stored at the computing device.

At block 740, the computing device receives content item(s). The content item(s) may arrive as an electronic file recognizable by the computing device (e.g., a text or proprietary file extension), or a communication message (e.g., email, text message) that includes the relevant information. The computing device can analyze (e.g., parse, store) the content item(s) in order to identify the content items received from the server (e.g., identifiers, receipt date). In some instances, metadata for a content item is analyzed to determine, e.g., a name of the content item, a channel for the content item, a type of the content item and/or a duration of the content item. The content item can be stored at a destination corresponding to a particular channel or general across channels. In some instances, receiving or storing a new content item initiates deletion of a previously stored content item (e.g., to keep a channel-specific or cross-channel item storage below a size threshold or item count). In some embodiments, the computing device accesses an application (e.g., a web browser, a software “app” on a mobile device) to communicate with one or more servers via the network to receive the content item(s).

At block 745, the computing device identifies a display-trigger event. For example, the computing device may identify an event indicative of entering a display state (e.g., some predetermined amount of time and/or time period of inactivity at the computing device). In some examples, the event is indicative of entering a display state corresponding with the user's request to enter a display state (e.g., detecting a selection of a predefined key (F10, F9), requesting to activate a GUI that allows the user to provide commands to enter and exit the display state through the GUI).

At block 750, the computing device displays one or more received content item(s). Which content items are displayed and/or an order in which they are displayed can depend on or be specified by one or more playlist. For example, a playlist may identify an ordered list of specific content items, and the computing device can then display the content items accordingly. As another example, the playlist may identify an ordered list, where each list item corresponds to a content-item constraint (e.g., indicating that the content item is to be selected from amongst a specified group of items, is to correspond to a specified channel and/or is to be of a specified type).

In some instances, content items will continue to be received from the server during a display. For example, a server can push a first two content items in a playlist to a computing device. The computing device can then request additional content items upon entering display mode. The server can then push a batch of content items corresponding to a next portion (or a remaining portion) of the playlist.

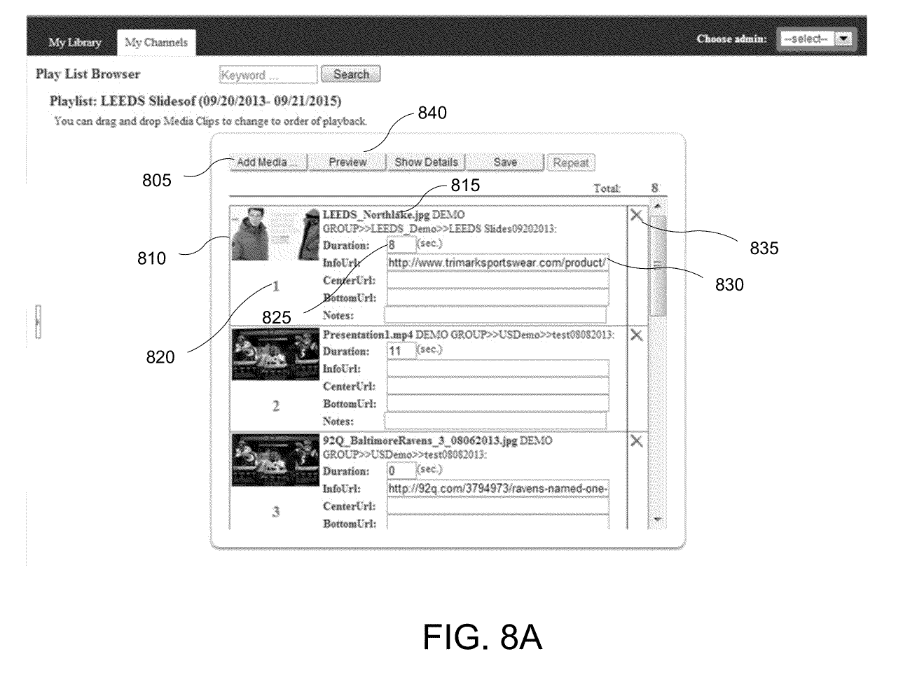

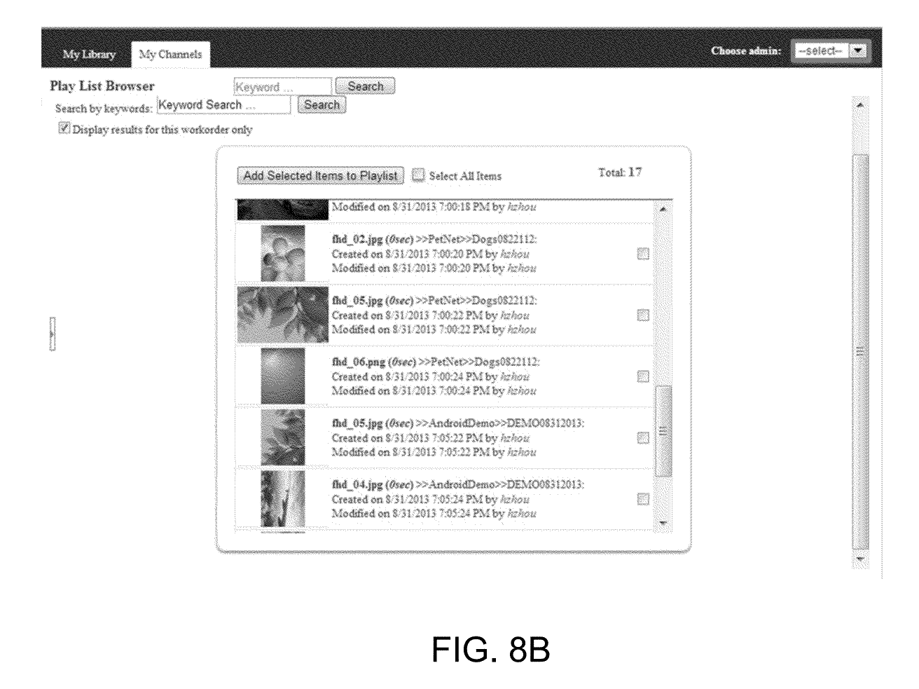

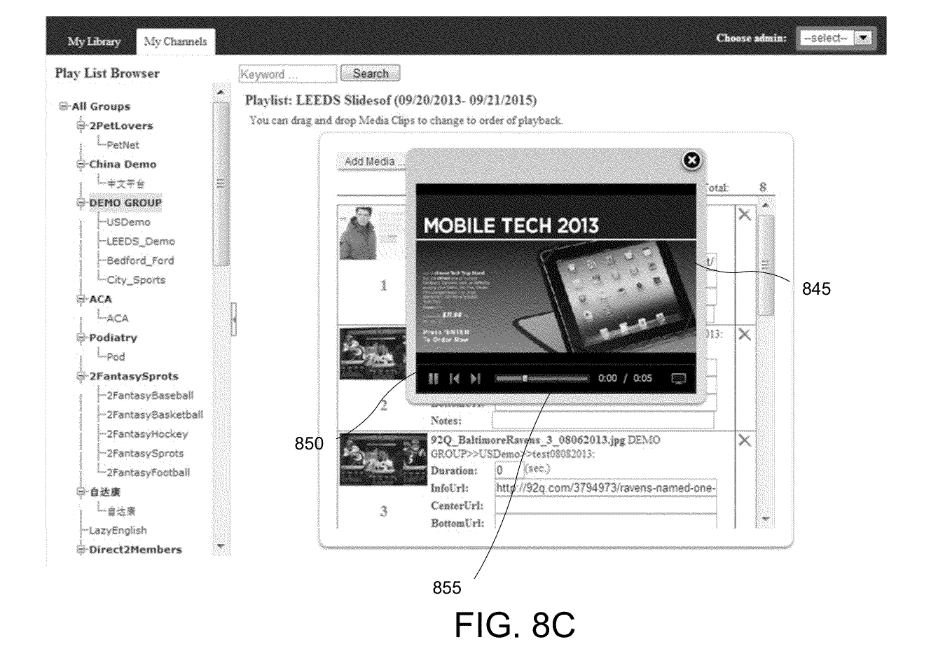

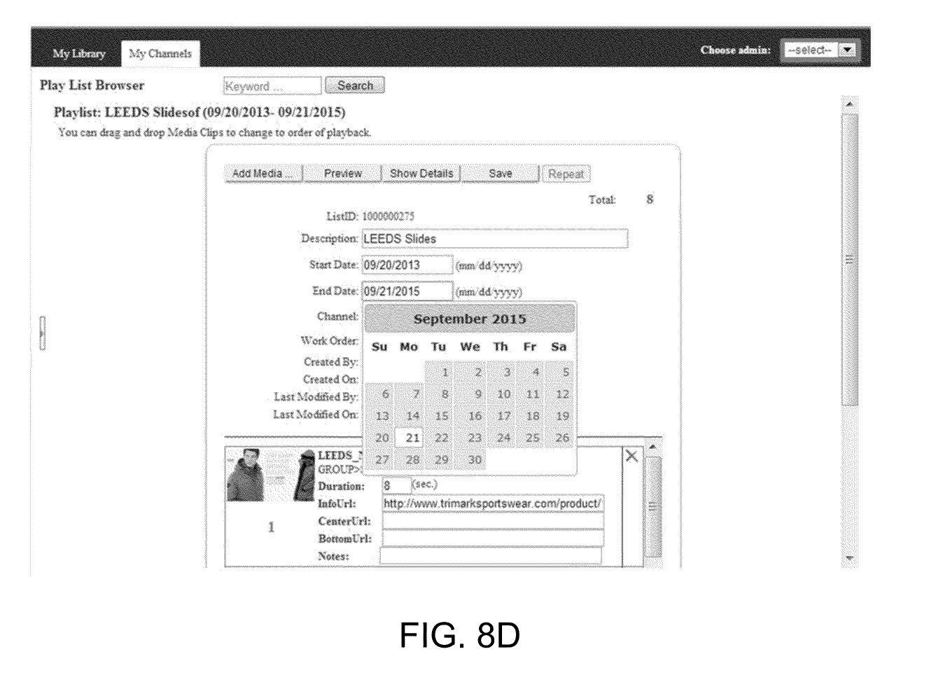

As mentioned, a playlist can be influenced based on inputs provided by one or more publishers and/or a user. FIGS. 8A-8D show illustrations of interfaces configured to receive publisher inputs pertinent to a playlist according to an embodiment of the invention.

FIG. 8A presents identifiers of content items in a playlist and allows a publisher to modify the playlist. A publisher can press the “add media” button 805 to locate a content item to add to the playlist. Upon selection of the button, a list of content items that are available for addition to the playlist can be presented. FIG. 8B illustrates an example of a display that can be presented responsive to the selection of the add-media button. As shown, the list can include, for each of one or more content items, a representative image (e.g., an image itself or screenshot), a title, a creation date, a publisher that uploaded the item, a modification date and/or a file type. In some instances, the list can include some or all content items associated with one or more particular channels or publishers. The list can include content items uploaded to a channel or identified as being associated with a channel. In some instances, an opportunity to upload or identify a new content item can also be provided.

Upon selecting a content item, a representation of the item can be added to the interface. The representation can include a graphic 810 (e.g., an image or screenshot) and/or a name 815. The representation can be associated with a playlist position 820 (e.g., specifying where it is to stand within a playlist's order). In some instances, each added item is added to an end position (e.g., to an end of a sequence in the playlist). In some instances, a playlist position can be specified by the publisher upon adding the item. The item positions can be subsequently adjusted (e.g., by dragging and dropping item representations or reordering a list).

The GUI can include an item-duration input field 825. Thus, a publisher can be allowed to specify a duration for which a particular item (or a set of items or all items) is to be displayed. For images, the image can be statically presented for this time. For a video or audio stream, a clip of the video or audio stream (e.g., starting from the beginning or from a specified starting point) that is of the duration can be shown.

The GUI can include an option 835 that allows a publisher to remove a given content item from the playlist. Upon selecting the option 835, a representation of the item can be removed or reduced in the GUI.

A preview option 840 can allow a publisher to view a sequence of content items as specified by the playlist. Thus, the represented content items can be displayed in an order corresponding to the identified order positions and for durations as specified by publisher-defined durations. In one instance, a preview box 845 is displayed, as shown in FIG. 8C. The box includes a display section 850 that shows the playlist's content items, a set of player controls to allow a publisher to control the playlist's play (e.g., to play, pause, or skip forward/backwards) and a timer bar 855 that indicates a progression within the playlist. In various embodiments, a preview can allow a publisher to view a specific content item or a playlist-defined sequence of content items.

For a given publisher or channel, the temporal applicability of various content items may not conform across a playlist. For example, one item may relate to a sale that ends in a week and another may relate to a timeless customer-service philosophy of a company. To accommodate such variation, details of an individual content item can be adjusted to specify its temporal relevance. As shown in FIG. 8D, a publisher can select a start date and an end date specifying a time period during which a content item is to be included in a playlist. When a current time is not within the time period, other items with playlist positions below the item can be moved up in their playlist positions, and the item can be removed from the playlist.

FIGS. 8A-8D illustrate how information from publishers can be used to determine sequences for content items. However, whether this information is relevant to channel display of a given user can depend on channel selections or rankings. In one instance, a playlist can be generated specifically for a user. That playlist can depend on and/or include a playlist as defined by a publisher. For example, a user's playlist can include a sequence of in-full playlists defined by publishers or an interleaved sequence (e.g., such that a first item is the first item of Channel 1's playlist and a second item is the first item of Channel 2's playlist).

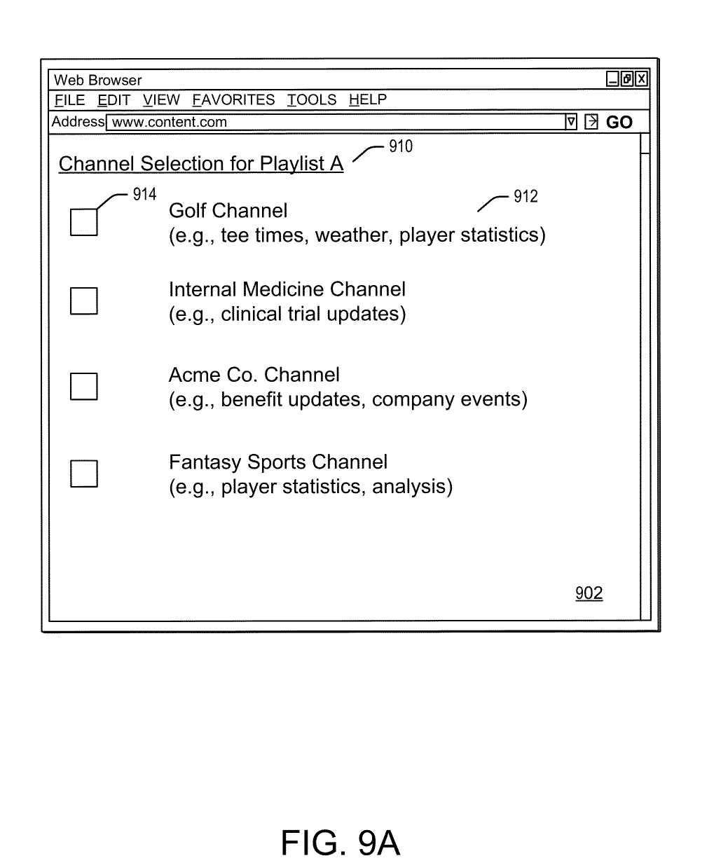

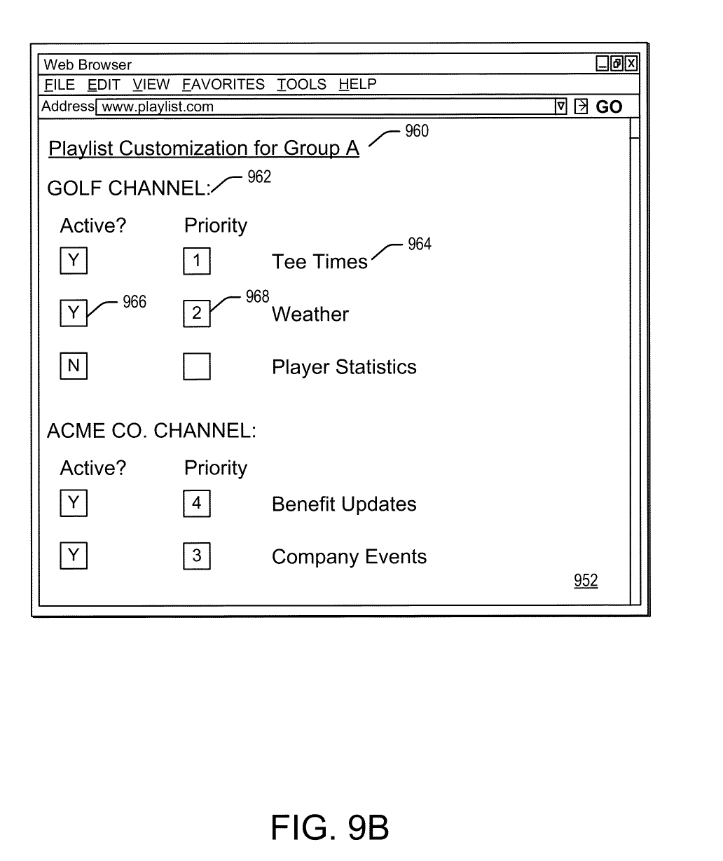

FIG. 9A shows an illustration of a graphical user interface (GUI) that allows a user to select channels for inclusion in a user playlist according to an embodiment of the present invention. In some embodiments, the GUI 902 may be provided via a network interface, web browser, or software application.

The GUI 902 can provide a list 910 of one or more channels available for user selection. In some embodiments, the list 910 can include some or all channels that the user or that a computing device is subscribed to. In some embodiments, the list 910 can include one or more channels that are recommended for a user. In the depicted example, the list 910 can include a golf channel, internal medicine channel, a company's channel (e.g., Acme Co.), or a fantasy sports channel. It will be appreciated that the list 910 of one or more channels is illustrative, and alternative channels, settings, options, or layouts are contemplated.

The list 910 may include information 912 about one or more channels. For example, a channel may include a title (e.g., golf channel) and illustrative content items provided via the channel (e.g., tee times, weather, player statistics). Alternatively or additionally, list 910 can include, for each channel, a brief description, one or more keywords, a channel fee and/or one or more types of content items. Multiple channels and summaries of information about the channel may be provided.

A user operating a computing device may interact with the list 910. For example, the user may select, tap, click, or otherwise activate a portion of the GUI 902 to identify one or more channels with which the user would like to receive content items.

The selections made via GUI 902 can serve to act as a preference or restriction (depending on the embodiment) influencing a structure of the playlist. In some instances, the playlist will only include content items for the selected channels. In some instances, the playlist will primarily include content items for the selected channels. Additional content items can include, e.g., advertising content items. In some instances, weights can be assigned to channels or content items in accordance with the selection (e.g., heavily weighting items for selected channels), and playlists can be generated based on the weights.

In response to the interaction, the GUI 902 may activate a channel and/or content item for a playlist. The playlist may be stored at the server and/or computing device, and include a listing of identifiers associated with the channel and/or content item. The GUI 902 may be configured to transmit the playlist to the computing device. The playlist can cause content items for the channel to be periodically presented at the computing device (e.g., based on instructions and/or identifiers in the playlist).

FIG. 9A shows a binary response to channel inclusion: either a channel is to be included in a playlist or it is not. A more detailed specification can subsequently or alternatively be provided. For example, the GUI may be configured to allow a user to rank the channels in terms of priority, set an order that the channels are to be included in a playlist (e.g., such that one, some or all items of a low-order channel are to be shown before one, some or all items of a high-order channel), set inclusion proportions or weights, and/or restrict (in or out) content-item types for one, some or all channels.

FIG. 9B shows an illustration of a graphical user interface (GUI) for providing more detailed playlist customization according to an embodiment of the present invention. In the illustrated embodiment, GUI 952 can be presented in response to a user selecting the Golf and ACME channels identified in GUI 902, though it will be appreciated that this more detailed interface may be presented prior to initial selections (e.g., including information pertaining to all subscribed, recommended or query-responsive channels).

The GUI 952 can provide a list 960 of one or more channels (e.g., that the user selected using GUI 902) for the user to customize with relation a playlist. The list 960 may include a list of channels 962. The channels can include those previously selected for playlist inclusion, those subscribed to and/or those recommended ro a user. For each channel, one or more categories 964 can be presented.

For each category, a user can interactive with an “active” option 966 to indicate whether the category is to be included at all in the playlist. The active option 966 may initially be set to a default value. For example, an opt-out protocol can be used, such that it is assumed that a user wishes to receive content from the category unless the user provides contrary indications.

The user can further prioritize each category using a prioritization option 968. In the depicted instance, the prioritizations can be relative to all categories. In another instance, the prioritizations can be relative to all categories for a given channel (which themselves may be prioritized relative to each other). In the illustrated example, the prioritization is numeric. It will be appreciated that alternative embodiments could include a level-based prioritization, such that a category can be assigned to, e.g., a high, medium or low priority, and multiple channel categories can be assigned to a given priority level.

In response to interactions with publisher and/or user GUIs, a detailed user-specific playlist can be generated. FIG. 10 shows an illustration of a playlist, an identification of a set of content items, an order for the content items, a presentation duration for each content item and a source of each content item. The playlist can further include a destination location for one or more content items.

The multimedia segment of the playlist identifies a type and duration for each content item. An order of the content items is further represented. An external application portion of the playlist identifies, for each content item, an application that is to be used to execute or otherwise display the content item. An application argument portion of the playlist identifies a destination for each content item. Thus, it will be appreciated that variables such as a display-enabling application, destination location and/or display duration can vary across content items.

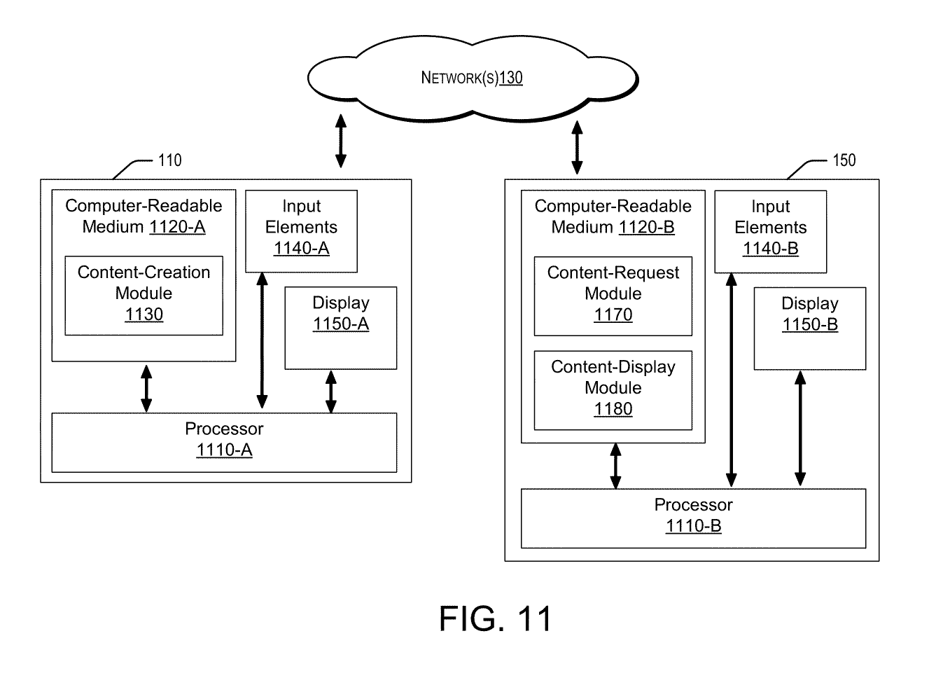

FIG. 11 illustrates a block diagram illustrating a system on a computing device for triggering presentation of content channels according to an embodiment of the present invention. The content-creation computing device 140 and a content-display computing device 150 (hereinafter “Devices”) may communicate directly (e.g., wired or wireless connection) or through a network 130.

In one illustrative embodiment, the devices may be any type of computing device such as, but not limited to, a mobile phone, a smart phone, a personal digital assistant (PDA), a laptop computer, a desktop computer, a thin-client device, a tablet PC, an electronic book (e-book) reader, etc. In some examples, the devices may be in communication with the servers via the network, or via other network connections. Additionally, the devices may be part of a distributed system managed by, controlled by, or otherwise part of the servers (e.g., a console device integrated with the publishing server 110 and/or the content delivery/receiving server 120).

The devices may include one or more processing units 1110 (e.g., 1110-A and 1110-B), at least one computer-readable non-transitory media 1120 (e.g., 1120-A and 1120-B), one or more input elements 1140 (e.g., 1140-A and 1140-B), and one or more displays 1150 (e.g., 1150-A and 1150-B).

The processor(s) 1110 may be implemented as appropriate in hardware, computer-executable instructions, firmware, or combinations thereof. Computer-executable instruction or firmware implementations of the processor(s) may include computer-executable or machine-executable instructions written in any suitable programming language to perform the various functions described. The processor 1110 may process the functions of the computing device.

The computing device may also be configured to include computer-readable non-transitory media 1120. The computer-readable non-transitory media 1120 may be in the form of a memory that stores program instructions that are loadable and executable on the processor(s) 1110, as well as data generated during the execution of these programs. Depending on the configuration and type of devices, the memory may be volatile (such as random access memory (RAM)) and/or non-volatile (such as read-only memory (ROM), flash memory, etc.). The devices may also include additional removable storage and/or non-removable storage including, but not limited to, magnetic storage, optical disks, and/or tape storage. The disk drives and their associated computer-readable non-transitory media may provide non-volatile storage of computer-readable instructions, data structures, program modules, and other data for the computing devices. In some implementations, the memory may include multiple different types of memory, such as static random access memory (SRAM), dynamic random access memory (DRAM), or ROM.

Turning to the contents of the content-creation computing device 140 memory in more detail, the memory may include an operating system, one or more application programs or services for implementing the features disclosed herein including at least providing and/or displaying content (e.g., through a content-creation module 1130), such as via a browser application or dedicated applications (e.g., smart phone applications, tablet applications, etc.). The browser application may be configured to receive, store, and/or display a website or other interface for interacting with the servers. Additionally, the memory may store access credentials and/or other user information such as, but not limited to, user IDs, passwords, and/or other user information. In some examples, the user information may include information for authenticating an account access request such as, but not limited to, a device ID, a cookie, an IP address, a location, or the like.

In some embodiments, the content-creation module 1130 can be configured to generate new content. For example, the content-creation module 1130 can be configured to capture an image, identify a file (e.g., stored locally on the computing device, stored remotely on a data store or distributed storage device), provide a link to a file (e.g., audio, image, video, text), or otherwise identify a new content. In some embodiments, the content may be available on the server's data store or previously provided to a channel so that the new content is “new” for a new or amended channel although not necessarily new to the server and/or data store.

The content-creation module 1130 may also be configured to upload the new content item. For example, once the new content is identified, the content may be uploaded, provided, and/or stored at the server as a new content item. The uploaded content may be identified by a publisher operating the computing device as a new content item. In some embodiments, the content-creation module 1130 may also be configured to associate a temporal factor with a new content item (e.g., time transmitted from a source to the computing device, time uploaded to the server from the computing device).

In some embodiments, the publisher may include information about the content item. For example, the content items can include an identifier, title, description, keywords, time to display the content item, or destination. The corresponding information may also include product information, promotion details, or institution-level notifications and can dynamically change in time.

In some embodiments, the publisher can periodically update content (e.g., images, videos or text) based on, e.g., current or future promotions, new product launches, or recent events. For example, a particular publisher may provide promotions based on a holiday season, so that the content items provided via the content-creation module 1130 in March may relate to Saint Patrick's Day while the content items provided via the content-creation module 1130 in July may relate to Independence Day. In another example, the publisher can periodically upload content items for a golf channel (e.g., images identifying results of recent golf tournaments, videos promoting sales on golf clubs, text about golfers, or text and images identifying weather conditions at nearby golf courses).

The content-creation module 1130 may also be configured to alter an existing content item. For example, the user may access a graphical user interface (GUI) that allows the user to search for uploaded content item(s), retrieve information provided about the content item, and/or provide updated information about the content item (e.g., a new destination, a new default display duration).

The content-creation module 1130 may also be configured to specify a destination of a content item. For example, the publisher can specify a destination (e.g., a webpage, such as an ordering webpage, an event-registration webpage, or an informational webpage) for each of one or more content items.

The content-creation module 1130 may also be configured to specify instances that can cause a user device to be directed to the destination. For example, pressing a particular key during a display of a content item can cause the user device to request and display a destination webpage. The webpage may provide additional information pertaining to the content item displayed.

The content-creation module 1130 may also be configured to provide feedback to a publisher. For example, a user may interact with a content item provided by a particular publisher and cause the device to route to the destination. A server and/or computing device may track the interaction and, when the server and/or device supports the generation of, e.g., marketing statistics for a publisher, the content-creation module 1130 may receive this information from the server and provide the marketing statistics to the publisher. It should be appreciated that the marketing statistics may be provided via a webpage, software “app”, or other method other than the content-creation module 1130.

The content-creation module 1130 may also be configured to generate and/or transmit an invitation to join a channel. For example, the invitation can include an identification of the channel and/or content item(s) provided by the channel. In some embodiments, the invitation may be based in part on an analysis and/or recommendation for one or more particular channels for the one or more content-display computing devices to accept or reject.

Turning to the contents of the content-display computing device 150 memory in more detail, the memory may include an operating system, one or more application programs or services for implementing the features disclosed herein including at least requesting, receiving, and/or displaying content (e.g., through a content-request module 1170 and/or a content-display module 1180), such as via a browser application or dedicated applications (e.g., smart phone applications, tablet applications, etc.). The browser application may be configured to receive, store, and/or display a website or other interface for interacting with the servers. Additionally, the memory may store access credentials and/or other user information such as, but not limited to, user IDs, passwords, and/or other user information. In some examples, the user information may include information for authenticating an account access request such as, but not limited to, a device ID, a cookie, an IP address, a location, or the like.

In some embodiments, the content/channel request module 1170 can be configured generate a subscription request. For example, the computing device accesses an application (e.g., a web browser, a software “app” on a mobile device) to communicate with one or more servers via the network to submit the subscription request. The application can present a form (e.g., via an application programming interface (API)) or similar type of graphical user interface (GUI) to accept user input that is relevant to the one or more content items.

In some embodiments, the subscription request can cause content items for the channel to be periodically sent to the computing device for display on the computing device. For example, the subscription request can contain information about the requester or request, including one or more identifiers of the user (e.g., name, email address, phone number), identifiers of the computing device (e.g., an IP address), identifiers of a type of device (e.g., mobile device, laptop, desktop, tablet or particular brand thereof), identifiers of the content item(s) and/or channel, operating system(s), channel-related preferences (e.g., when content items are to be received, a limit on a number of content items, a type of content item such as image or video, whether to accept sound-inclusive content items, size of screen, a number of current channel subscriptions, historical time in display mode, where the channel will be ranked amongst other channels, etc.), or other information.

The content/channel request module 1170 may also be configured to identify a user, so that the subscription request corresponds with a user for one or more computing devices, rather than corresponding with a particular computing device.

The content/channel request module 1170 may also be configured 1111 to transmit a subscription request to subscribe to a channel. For example, the computing device accesses an application (e.g., a web browser, a software “app” on a mobile device provided by the content/channel request module 1170) to communicate with one or more servers via the network to submit the subscription request. The application can present a form (e.g., via an application programming interface (API)) or similar type of graphical user interface (GUI) to accept user input that is relevant to the one or more content items. The user may interact with the application and prompt a generation of a subscription request that includes the information. The subscription request can be transmitted to the server via a network (e.g., the Internet). In other examples, the user can send a communication message (e.g., email, phone call) that includes the relevant information, which the server can analyze (e.g., parse, store).

The content/channel request module 1170 may also be configured to determine a playlist. For example, the subscription request may request weather information when the device enters an idle state. The content/channel request module 1170 may be configured to identify a weather rule and alter an existing playlist (e.g., adding the rule) or generate a new playlist that includes the rule. In some embodiments, as shown above, the server (e.g., the user module 420 at the publishing server 110) may alternatively determine a playlist.

The content/channel request module 1170 may also be configured to request additional information from a server. For example, the computing device can transmit a communication (e.g., including an identification of the content item) to the server. The server may respond to the communication with an identifier of the destination.

The content/channel request module 1170 may also be configured to provide information to a server and/or publisher to enable a server and/or publisher to generate a recommendation. For example, the recommendation can be based in part on a content-display computing device's past history (e.g., subscription, destination access), past preferences (e.g., priorities, playlists), likes/dislikes, explicit searches (e.g., received prior to a subscription request), or location-based searches (e.g., zip code of the location of a computing device, address of a user, identification of nearby stores to a user that provide content items).

In some examples, the content-display module 1180 may be configured to receive content items sent to the computing device from a server. In some embodiments, the content-display module 1180 may be configured to receive content items when the device is in a channel state (e.g., via a network). In some embodiments, the content items may be received periodically at the content-display computing device 150.

The content-display module 1180 may also be configured to present the content item (e.g., while the computing device is in the display state). For example, the content-display module 1180 may interact with the display 1150-B to display the content item(s) via a user interface. In another example, the computing device may display the content item so that the content item is actively running on the computing device on top of the previously actively running application. The content item may be actively running when a content item is presented at the computing device. For example, the graphic, text, or series of graphics (e.g., in a video) can be presented on all or part of a display. When portions of the display are used to provide different content items at the same time, one or more of the portions of the display may provide one or more content items. When the content item includes sounds (e.g., an audio track, an audio/visual file), the sound can be output via a speaker at the computing device. In some examples, portions of the display at the computing device can be turned into a link area, such that an input corresponding to the area (e.g., a cursor click on the area) can cause destination information to be presented (e.g., an ecommerce page associated with the item presented as a content item).

The content-display module 1180 may also be configured to present content item(s) sequentially, in a particular order (e.g., based on a playlist or based on a priority rating provided by the computing device). For example, if a user subscribes to two channels, including a medicine channel that provides information on new drugs and clinical trials and a company event channel that provides information from a user's employer about new events provided by the company, the computing device may present the content items associated with the medicine channel before the any content items associated with the company event channel.

The content-display module 1180 may also be configured to present the content items according to a playlist. As discussed, a playlist may include one or more identifiers, where an identifier can identify one or more content items received through a channel that are displayed by the computing device. For example, the playlist may include one identifier for a content item from the golf channel, two identifiers for two content items from a company events channel, and one identifier for a content item from an internal medicine channel.

The content-display module 1180 may also be configured to determine which items to present. For example, upon detecting the event, the computing device may access the stored location of the received content items and present (e.g., display on the entire screen or a portion of the screen associated with the computing device, play audio content items via a speaker) any received content items. The presented content items can include a sequential or interleaved presentation of all content items received from the server, all content items associated with a particular channel, a subset of the content items in one or more channels, only new content items (e.g., content items received in the most recent transmission), recently received content items (e.g., over the past day regardless of the number of content items received the most recent transmission), or a specific number of content items.

The determination of which content items to present can consider a variety of factors. For example, one or more channels may be ranked (e.g., based on the user's priority for viewing the content associated with the channel), and the content items associated with a particular highly-ranked channel may be displayed before other channels that are not as highly-ranked. In another example, the content items within the channel may be ranked (e.g., based on the user's priority for viewing particular types of content within a particular channel, including weather content items before player statistic content items in a golf channel), and the content items associated with a particular high ranking in the channel may be displayed before other content items in the same or other channels that are not as highly-ranked.

In some embodiments, the determination of which content items to present can be based on a user's past interaction with the computing device. For example, a content item associated with women's shoes may be displayed and selected by the user, directing the computing device to access the destination associated with the content item to purchase the shoes (e.g., an ecommerce shopping webpage). The content display module 1180 can be configured to determine that the user is more interested in women's shoes than weather. In a subsequent presentation of content items, the content items associated with women's shoes, women's fashion, and/or another related topic can be ranked higher than other content items and displayed before other content items.

In some embodiments, the presenting of content items at the computing device can be associated with a temporal factor. For example, the temporal factor can include a time (e.g., an hour, minute, day, or date) at which the content item was uploaded to or otherwise received at the server (e.g., from a publisher), a time at which the content item was transmitted to or received at the computing device, a time at which the content item was displayed at the computing device, or the time at which the content item was transmitted from the server to the computing device. These times can be used (globally or within a channel) to, e.g., bias towards showing older content items first or showing newer content items first. In some examples, the higher ranked content items may be presented in association with the time. In some examples, the content items can be presented in association with upcoming sales, events, or other specified times.

The content-display module 1180 may also be configured to randomly select content items for presentation. The determination of which content items to present may include a random selection and/or sequential ordering. For example, the content items may be presented in the order that the items were received from the server during the channel state (e.g., most recent items first). In another example, the content items may be presented based on alphabetical listing, identifier ordering, or purely random ordering.

The content-display module 111180 may also be configured to detect an event indicative of entering a display state. For example, the event may include a period of inactivity, interaction with a keyboard (e.g., a selection of a predefined key, like an F10 key to enter the display state), cursor movement, voice command, or a pre-determined amount of time.

The content-display module 1180 may also be configured to detect an event indicative of exiting a display state. For example, the event may include an interaction with a keyboard (e.g., a selection of a predefined key, like an F9 key to exit the display state), cursor movement, voice command, or a pre-determined amount of time. In another example, the computing device can cease display of the content item(s) (e.g., the content items are, at least temporarily, no longer displayed on a screen of the computing device, audio is no longer played by the computing device speakers, and other forms of presentation are terminated).

The content-display module 1180 may also be configured to detect an interaction with the content item, including an interaction that identifies that the user would like to access a destination associated with the content item. For example, the interaction may include a selection of a predefined key, like an enter key or spacebar. In some embodiments, the user may press Alt-Tab to activate a graphical user interface (GUI) that allows the user to provide commands to interact with the content item and/or access the destination.

The content-display module 111180 may also be configured to enable the computing device to display content from a destination. In some embodiments, the destination may include a webpage, such as an ordering webpage, an event-registration webpage, or an informational webpage.

The content-display module 1180 may also be configured to determine a user's interests and/or adjust the priority/sequence of presentation. For example, the computing device can display content items related to weather and women's shoes. The user may access the destination associated with the content item to purchase the shoes (e.g., an ecommerce shopping webpage). The computing device can determine that the user is more interested in women's shoes than weather. In a subsequent presentation of content items, the content items associated with women's shoes, women's fashion, and/or another related topic can be ranked higher than other content items and displayed before other content items.

The content-display module 1180 may also be configured to help track displays and/or interactions with one or more content items. The tracking may support generation of, e.g., marketing statistics for a publisher and/or may be transmitted to a server to compile with other information.

The computing device may also be configured to include one or more input elements 1140 to allow a user to input information into the computing device (e.g., keyboard, a mouse, a pen, a voice input device, a touch input device, and the like). In some embodiments, the one or more input elements may also include elements to accept wired or wireless data transfer (e.g., data transmission).

The content-creation computing device 110 and content-display computing device 150 may also include other features. For example, the computing device may also be configured to include a display 1150 to allow a user to view one or more content items, message, and other information provided by the computing device.

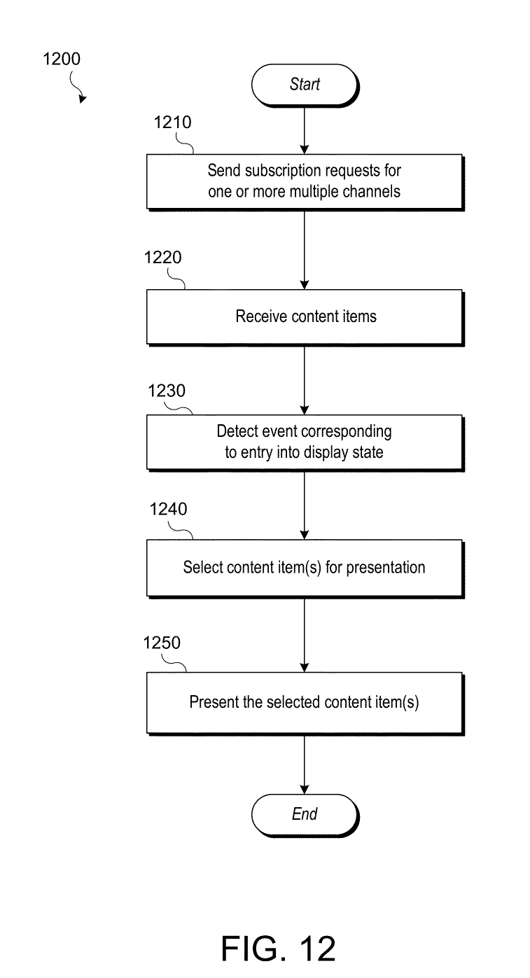

FIG. 12 illustrates an example flow diagram of a process 1200 for presenting channel content items according to an embodiment of the present invention. Process 1200 can be performed, e.g., by a computing device (e.g., of a user).

The process 1200 may begin at block 1210 by sending one or more subscription requests (e.g., to a server). Each subscription request can identify one or more channels. Each subscription request can further identify a user and/or computing device. In some instances, the subscription request identifies a user ranking or priority level for the channel. A subscription request can further include one or more limitations, such as types of content items or content categories to exclude or to be restricted to.

At block 1220, one or more content items can be received. The content item(s) can be responsive to the subscription request(s). In some instances, multiple content items are received (e.g., simultaneously or at different times), with at least some content items corresponding to different channels.

In some instances, at least one received content item is stored and not immediately displayed. In this instance, it can be hidden from other programs behind active content. Thus, a current display of a computing device can be focused on other active content or other screens (e.g., a desktop screen).

In some embodiments, the content item(s) associated with multiple channels may be stored in one or more locations. For example, the content items associated with one channel may be stored in a first data store (e.g., while the active content is displayed and the content items are hidden) and content items associated with a second channel may be stored in a second data store. In some examples, the content items may be stored in the same location with additional information to identify the channel association for the content item. For example, the data store can include a particular file structure to store and organize the content item(s) (e.g., by file name, date, size, file type, channel-type). The content items may be sorted or retrieved dynamically from the data store. In yet another example, the data store can be a transitive data store where content items are stored temporarily (e.g., cache) and/or deleted after a determined amount of time.

At block 1230, an event corresponding to the entry into a display state is detected. For example, the event can include passage of a threshold amount of time of inactivity at the computing device or detection of a particular keystroke or cursor selection. The event can cause the computing device to enter the display state.

At block 1240, one or more content items are selected for presentation. The selection can be based on, e.g., a playlist (e.g., selecting all content items in a playlist or selecting a first content item or a first group of content items in the playlist), channel rankings or priority, a publisher's rankings or specifications prioritizing items, pseudo-random selection, times associated with content items, a current time and/or which content items were previously presented to a user or on a computing device. In one instance, a user can dynamically change which channels, from amongst a set of subscribed-to channels, are to be used for presentation. Content—item selections can then be accordingly restricted.

At block 1250, the process presents the identified content item(s). In instances in which multiple content items are selected at block 1240, the items can be presented in an order based on, e.g., a playlist (e.g., selecting all content items in a playlist or selecting a first content item or a first group of content items in the playlist), channel rankings or priority, a publisher's rankings or specifications prioritizing items, pseudo-random selection, times associated with content items, a current time and/or which content items were previously presented to a user or on a computing device. Content items can be seamlessly presented, such that an end of a presentation of one content item substantially coincides with a beginning of a presentation of another content item.

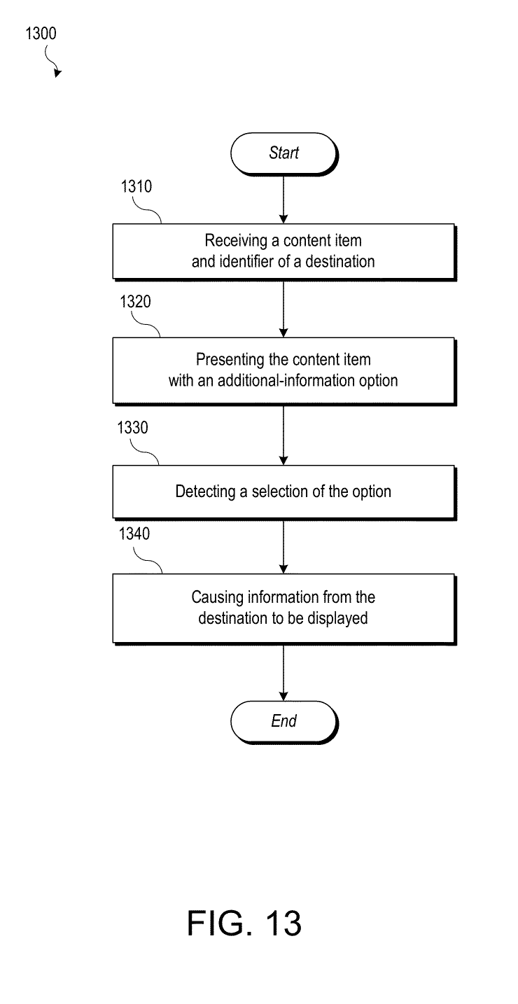

Content items can be presented in an interactive manner, whereby user interactions can influence what material is presented. In one instance, the effect of an interaction can be differentially defined for individual content items. FIG. 13 illustrates an example flow diagram of a process 1300 for displaying interactive channel content at a computing device according to an embodiment of the invention. As shown, various portions of the process can be performed by a computing device and/or a server. For example, blocks 1310-1330 can be performed by a computing device and block 1340 can be performed by a computing device or a server.

The process 1300 may begin at block 1310 by receiving a content item and identifier of a destination from a server. As described herein, the transmission of a content item (e.g., and an associated destination) can be triggered by an event such as entry into a display state, receipt at the server of a new content item, or detection that the computing device has access to the network and can accept content from the content delivery/receiving server 120. In another example, the computing device may receive the content item and identifier of a destination at defined times or intervals (e.g., daily, hourly, upon request to receive a content item, upon request to push a content item, based on a recurring subscription/rule).

As described herein, the content item may include an image, video, stream of data, audio, text, or other data provided to a computing device in an electronic format. The content item can include, e.g., product information, promotion details, event details, news, educational information and/or institution-level notifications and can dynamically change in time. In one instance, a computing device can periodically receive content based on current or future promotions, new product launches, or recent events from a publisher/server.

The identifier of a destination may be a location on a network page that is provided to the computing device when the computing device interacts with a content item. For example, a content item may include an item for sale, such as a pair of shoes. When a specific interaction with the computing device is detected, the computing device may be directed to the destination that sells the shoes, including a network page at a particular uniform resource locator (URL).

The computing device can receive the content item and identifier of a destination as a message from the server via a transmission channel. In some embodiments, the message may include additional information, including information about the publisher, an identifier of a user (e.g., name, email address, phone number), an identifier of an originating computing device (e.g., an IP address), an identifiers of the content item(s) and/or channel, or other information.

At block 1320, the process presents the content item. The content item can be presented in accordance with one or more applicable playlists. The content item can be presented for a duration as identified in correspondence with the content item or in a playlist. The presentation can include a visual and/or audio presentation.

The content item can be presented upon detecting a display event. For example, when the user is interacting with the computing device (e.g., by opening a document), the user may leave the document open while the device becomes inactive. The process may display one or more content items as active content, instead of or on top of the document on the display screen.

In some embodiments, the presentation of content item(s) and/or additional information may be displayed according to a playlist. For example, when the playlist identifies Image A as the first image to present for 5 seconds and identifies Image B as the second image to present for 10 seconds, the computing device may display the images as instructed.

The presentation can include an visible or invisible option to access additional information. For example, an explicit option can include presentation of a button or text indicating that selection of the button or entry of particular commands can direct the user to information related to the content item. An implicit option can allow for user interaction to direct the user to the destination but the display can lack any particular button, text or other indication about the commands necessary to prompt such action. In either scenario, the presentation can (but need not) include an interactive portion (e.g., box, link, image), where interaction with the interactive portion (any interaction or specific interaction) can direct the computing device to the destination. Additional information option can identify that additional information is available to a user. The additional information option may also or alternatively identify that a destination is associated with a particular content item.

At block 1330, the process detects a selection of the option. For example, the user can interact with the interactive portion by e.g., clicking, tapping, selecting, or swiping the interactive portion. In some instances, the user enters one or more keystrokes.

At block 1340, the process causes information from the destination to be displayed. For example, when the selection of the option is detected, the computing device may identify a destination provided by a publisher (e.g., a webpage, such as an ordering webpage, an event-registration webpage, or an informational webpage) for each of one or more content items. The computing device can communicate with the destination and/or receive information from the destination. The computing device can display the information received from the destination. In one instance, the computing device is directed to the destination. For example, a user can be directed to a destination webpage, such that it is displayed in a browser. In some (but not all) embodiments, display of destination information causes display mode to end.

FIG. 14 illustrates an interaction between a computing device and server for displaying a destination according to an embodiment of the present invention. A computing device 1402 may communicate through a network 1404 with a server 1406 (e.g., via a web browser, via a software “app”). For example, the computing device 1402 can submit a subscription request to receive content item(s) from one or more channels. The server 1406 can identify one or more content items associated with the subscription request and prepare the content items to transmit to the computing device. The content items may be transmitted by the server 1406 to the computing device 1402, including one or more content items (e.g., during a channel state).

The computing device 1402 may present a content item 1410 via an application (e.g., during a display state). The application 1410 may include a web browser or software “app,” so that the content item is noticeable when it is presented (e.g., displayed with a border, identified as a content item with a title or description). In some embodiments, the application 1410 may be unnoticeable (e.g., no border or splash screen before the application starts presenting content items). In some embodiments, the application 1410 may present the content item (e.g., image or video) at a full-screen so that a border of the application 1410 is not visible when presenting the content item(s).

The computing device 1402 may interact with the content item. For example, the user may press a key (e.g., space bar, enter key) to direct the computing device to display a destination 1412. The computing device may present the destination in the application 1410 (not shown).

In some embodiments, the destination 1412 is provided in a secondary application. For example, when the application that presents the content items is an app, the secondary application that presents the destination associated with the content item is a web browser. In some embodiments, the destination 1412 may be presented on top of application 1410.

It is understood that the various embodiments described herein are by way of example only, and are not intended to limit the scope of the invention. For example, many of the materials and structures described herein may be substituted with other materials and structures without deviating from the spirit of the invention. The present invention as claimed may therefore include variations from the particular examples and preferred embodiments described herein, as will be apparent to one of skill in the art. It is understood that various theories as to why the invention works are not intended to be limiting.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

Although many embodiments were described above as comprising different features and/or combination of features, a person of ordinary skill in the art after reading this disclosure may understand that in some instances, one or more of these components could be combined with any of the components or features described above. That is, one or more features from any embodiment can be combined with one or more features of any other embodiment without departing from the scope of the invention.

As noted previously, all measurements, dimensions, and materials provided herein within the specification or within the figures are by way of example only.

A recitation of “a,” “an,” or “the” is intended to mean “one or more” unless specifically indicated to the contrary. Reference to a “first” component does not necessarily require that a second component be provided. Moreover reference to a “first” or a “second” component does not limit the referenced component to a particular location unless expressly stated.

What is claimed is:

1. A computer-implemented method, comprising:
identifying a computing device that is configured to display channel content;
identifying a channel that is associated with the computing device;
detecting an event indicative that a content item associated with the channel is to be transmitted to the computing device;
identifying a content item that is associated with the channel;
identifying a destination associated with the content item, wherein an interaction with the content item at the computing device causes the information from the destination to be sent to the computing device; and
transmitting the content item associated with the channel and an identification of the destination to the computing device.

2. The computer-implemented method of claim 1, wherein the event is based on a detection of a new content item.

3. The computer-implemented method of claim 1, wherein the event includes an indication that the computing device has entered a display state, wherein content items associated with the channel or another channel are being displayed.

4. The computer-implemented method of claim 1, wherein the transmission includes streaming to the computing device.

5. The computer-implemented method of claim 1, wherein the content item is configured to automatically be displayed on the computing device without additional interaction.

6. The computer-implemented method of claim 1, wherein the content item includes an advertisement.

7. The computer-implemented method of claim 1, wherein the content item includes information about a product, event or service, and wherein the destination includes additional information about the product, event or service.

8. The computer-implemented method of claim 1, wherein the content item includes information about a fact, product, event or service in a financial, legal, or medical industry.

9. The computer-implemented method of claim 1, further comprising:
identifying a set of computing devices, wherein each computing device in the set of computing devices is configured to display channel content, and wherein the set of computing devices includes the computing device;
determining that each computing device in the set of computing devices is subscribed to the channel; and
transmitting the content item associated with the channel and the identification of the destination to each computing device in the set of computing devices.

10. The computer-implemented method of claim 1, further comprising:
receiving content items from the computing device; and
adding the content items to a channel.

11. A system, comprising:
at least one memory that stores computer-executable instructions; and
one or more processors configured to access the at least one memory, wherein the one or more processors is configured to execute the computer-executable instructions to collectively at least:
identify, using the one or more processors, a computing device that is configured to display channel content;
identify a channel that is associated with the computing device;
detect an event indicative that a content item associated with the channel is to be transmitted to the computing device;
identify a content item that is associated with the channel;
identify a destination associated with the content item, wherein an interaction with the content item at the computing device causes the information from the destination to be sent to the computing device; and
transmit the content item associated with the channel and an identification of the destination to the computing device.

12. The system of claim 11, wherein the content item is configured to automatically be displayed on the computing device without additional interaction.

13. The system of claim 11, wherein the content item includes an advertisement.

14. The system of claim 11, wherein the event includes an indication that the computing device has entered a display state, wherein content items associated with the channel or another channel are being displayed.

15. The system of claim 11, wherein the content item includes information about a product, event or service, and wherein the destination includes additional information about the product, event or service.

16. The system of claim 11, wherein the content item includes information about a fact, product, event or service in a financial, legal, or medical industry.

17. One or more computer-readable non-transitory media storing computer-executable instructions that, when executed by one or more computer systems, configure the one or more computer systems to perform operations comprising:
identify, using the one or more processors, a computing device that is configured to display channel content;
identify a channel that is associated with the computing device;
detect an event indicative that a content item associated with the channel is to be transmitted to the computing device;
identify a content item that is associated with the channel;
identify a destination associated with the content item, wherein an interaction with the content item at the computing device causes the information from the destination to be sent to the computing device; and
transmit the content item associated with the channel and an identification of the destination to the computing device.

18. The computer-readable non-transitory media of claim 17, wherein the content item is configured to automatically be displayed on the computing device without additional interaction.

19. The computer-readable non-transitory media of claim 17, wherein the content item includes an advertisement.

20. The computer-readable non-transitory media of claim 17, wherein the event is based on a detection of a new content item.
